(19) United States
(12) Patent Application Publication
(10) Pub. No.: US 2026/0300920 A1
(43) Pub. Date: Oct. 1, 2026

(54) USER-SPECIFIC CONTENT GENERATION NOTIFICATIONS FOR ELECTRONIC DOCUMENTS OF A CONTENT COLLABORATION PLATFORM

(71) Applicant: Atlassian Pty Ltd., Sydney (AU)

(72) Inventors: Kasirajan Selladurai Selvakumari, Sunnyvale, CA (US); Nikhill Lahoti, Sunnyvale, CA (US); Rudra Saha, Jersey City, NJ (US); Kenta Kawaguchi, Salt Lake City, UT (US); Annie lieu, San Francisco, CA (US); Thirumalaivelu Alagianambi, Mountain View, CA (US); Henry Jetmundsen, Seattle, WA (US); Blake Williams, Las Vegas, NV (US); Tammy Gu, Berkeley, CA (US)

(21) Appl. No.: 19/094,697

(22) Filed: Mar. 28, 2025

(51) Int. Cl. G06Q 10/101

(52) U.S. Cl. CPC G06Q 10/101

(57) ABSTRACT

Embodiments described herein relate to systems and methods for generating and displaying content change summaries with respect to two versions of a content item. An event history log may be analyzed to identify a cached content item associated with a prior view event of the content item with respect to a particular user. A generative summary of the changes may be generated by providing content extracted from the prior or current version of the content item, and a content delta. A generative summary having a topically arranged list of content change summaries may be produced from the generative response and displayed to a user.

### TECHNICAL FIELD

Embodiments described herein relate to content collaboration platforms and, in particular, to systems and methods for generating content to be displayed in a graphical user interface of the content collaboration platform.

### BACKGROUND

An organization can establish a collaborative work environment by self-hosting, or providing its employees with access to, a suite of discrete software platforms or services to facilitate cooperation and completion of work. Such software platforms may facilitate creating, editing, storing, viewing, collaborating on, and sharing of content items. In some cases, content items may be edited or developed over time, which may result in multiple versions of the content items.

### SUMMARY

A computer-implemented method for generating and displaying content change summaries within a graphical user interface of a content collaboration platform may include, in accordance with a successful authentication of a user account of a user operating a frontend application on a client device, causing display of the graphical user interface of the content collaboration platform, the graphical user interface including a content region including an editor for receiving user-generated content and displaying current content of a target page, in response to a trigger condition being satisfied, obtaining an event history log associated with the target page, analyzing the event history log to identify a cached page associated with a prior view event of the target page with respect to the user account, determining a content delta using first content extracted from the cached page and second content extracted from the target page, and causing generation of a prompt. The prompt may include predetermined query prompt text including text-based instructions, the first content extracted from the cached page, and the content delta. The method may further include obtaining a generative response from a generative output engine, the generative response produced in response to the prompt being provided to the generative output engine, processing the generative response to produce a generative summary having a topically arranged list of content change summaries, and causing display of the generative summary within a window object in the graphical user interface. The prior view event may correspond to a most recent historical page view event associated with the user account and the target page.

The prompt may further include instructions to generate the list of content change summaries, each content change summary of the list of content change summaries used to generate the topically arranged list of content change summaries, the prompt may further include instructions to preserve a respective text snippet for each content change summary of the list of content change summaries in the generative response, processing the generative response may include generating a selectable element for each content change summary of the list of content change summaries, and user selection of a particular selectable element may cause the frontend application to cause display of a respective portion of the target page containing the respective text snippet. The frontend application may be a browser application, and selection of the particular selectable element causes generation of a uniform resource identifier including at least a portion of the respective text snippet.

The topically arranged list of content change summaries may include at least one topic heading generated by the generative output engine, and at least one content change summary below the at least one topic heading. The method may further include analyzing the event history log to identify a set of events occurring between a timestamp associated with the cached page and a timestamp of the target page, generating an event summary based on the set of events, and causing display of the event summary in the window object of the graphical user interface.

The method may further include, subsequent to causing display of the generative summary and in response to a subsequent trigger condition, determining a subsequent content delta, in accordance with a determination that the subsequent content delta does not satisfy a modification threshold, causing generation of a full summary of the current content, and causing display of the full summary within the window object.

The current content may include editor-specific rich text elements, the editor-specific rich text elements may be replaced with placeholders in the first content extracted from the cached page and in the content delta, and prior to displaying the generative summary, the editor-specific rich text elements may be inserted into the topically arranged list of content change summaries.

A system of a content collaboration platform may include one or more processing units and computer readable memory storing computer readable instructions that when executed by the one or more processing units cause the system to, subsequent to an authentication of a user account of a user operating a frontend application on a client device, cause display of a graphical user interface of the content collaboration platform, the graphical user interface including a content region displaying current content of a target document, identify a previously saved document associated with a prior view event with respect to the user account, determine a content delta using first content extracted from the previously saved document and second content extracted from the target document, and cause generation of a prompt. The prompt may include predetermined query prompt text including text-based instructions, the first content extracted from the previously saved document, and the content delta. The instructions may further cause the system to obtain a generative response from a generative output engine, the generative response produced in response to the prompt being provided to the generative output engine, process the generative response to produce a generative summary having a set of content change summaries, and cause display of the generative summary within a window object in the graphical user interface. Identification of the previously saved document may be performed in response to a user selection of a selectable control displayed in the graphical user interface. Identification of the previously saved document may be performed by analyzing an event history log of the target document, and the previously saved document may be associated with a prior view event of the event history log with respect to the user account.

The generative summary may include a set of selectable elements, each selectable element positioned adjacent to a respective content change summary of the set of content change summaries, and selection of a particular selectable element may cause the graphical user interface to display a respective portion of the target document corresponding to a particular content change summary displayed adjacent to the particular selectable element.

The generative summary may include a set of topic headings generated by the generative output engine, wherein each topic heading may be associated with at least one content change summary of the set of content change summaries. The computer readable instructions may further cause the system to subsequent to causing display of the generative summary, determine a subsequent content delta, in accordance with a determination that the subsequent content delta does not satisfy a modification threshold, cause generation of a full summary of the current content of the target document, and cause display of the full summary within the window object.

A computer-implemented method for generating and displaying content change summaries within a graphical user interface of a content collaboration platform may include causing display of a graphical user interface of the content collaboration platform, the graphical user interface including an event history log for a target content item, the event history log including identifiers of a set of one or more previously saved versions of the target content item, in response to a user input, identifying a particular previously saved version of the target content item, determining a content delta using first content extracted from the particular previously saved version of the target content item and second content extracted from a current version of the target content item, and causing generation of a prompt, the prompt including predetermined query prompt text including text-based instructions, one or more of the first content or the second content, and the content delta. The method may further include obtaining a generative response from a generative output engine, the generative response produced in response to the prompt being provided to the generative output engine, processing the generative response to produce a generative summary having a set of content change summaries, and causing display of the generative summary within a window object in the graphical user interface.

The graphical user interface may be displayed subsequent to a successful authentication of a user account associated with a frontend application operating on a client device, and the event history log includes one or more events with respect to the set of one or more previously saved versions of the target content item.

The method may further include analyzing the event history log to identify a set of events occurring between a timestamp associated with the particular previously saved version of the content item and a timestamp of the current version of the target content item, generating an event summary based on the set of events, and causing display of the event summary in the window object of the graphical user interface.

The particular previously saved version of the target content item may be an item that is at least two versions older than the current version of the target content item. One or more of the set of one or more previously saved versions of the target content item may be generated in response to a publication of the target content item. The content collaboration platform may be one of a document management platform, or an issue tracking platform, and the target content item may be one of an electronic document hosted by the document management platform or an issue hosted by the issue tracking platform.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a system diagram that can include and/or may receive input from a generative output engine.

FIG. 2 depicts an example timeline of a user interaction with multiple versions of a content item.

FIG. 3 depicts an example sequence of events and operations for creating generative content in a content collaboration platform.

FIGS. 4A-4E depict an example graphical user interface that supports generative content creation for user-specific content change summaries in a content collaboration platform.

FIG. 5 depicts an example graphical user interface element corresponding to generative content creation in a content collaboration platform.

FIG. 6 depicts an example graphical user interface that supports generative content creation for content change summaries in a content collaboration platform.

FIG. 7 depicts an example process for generating user-specific content change summaries in a content collaboration platform.

FIG. 8A depicts a simplified diagram of a system, such as described herein that can include and/or may receive input from a generative output engine.

FIG. 8B depicts a functional system diagram of a system that can be used to implement a multiplatform prompt management service.

FIG. 9A depicts a simplified system diagram and data processing pipeline.

FIG. 9B depicts a system providing multiplatform prompt management as a service.

FIG. 10 shows a sample electrical block diagram of an electronic device that may perform the operations described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The present disclosure is generally directed to generating summaries of changes that have been made to content items, such as pages or documents, between user visits to the content items. More particularly, in a content collaboration platform, multiple users may be able to create, edit, and view content items (among other possible functions). Over time, content items may be modified numerous times by multiple users, resulting in a complex version history for the content item. And since multiple users may be able to modify the content item, it may not be immediately apparent to a user what changes have been made to the content item since they last visited or viewed the document. Moreover, since content items in a content collaboration platform may be long, even a markup relative to a prior version of a content item may not be an efficient or easily digestible way to convey how a content item has changed.

Accordingly, described herein is a content change generation service that generates user-specific content change summaries between different versions of a content item, where the content change summaries represent and/or summarize differences between the current version of a content item and the last version of the content item that the user viewed. In particular, when a user views a target content item, the content change generation service may determine the contents of the target content item when that user last viewed the target content item, and compare that version of the target content item to the current version of the content item to identify the differences between the two versions. The content change generation service may then use a generative output system to generate summaries of the differences, and display those summaries to the user. In this way, the content collaboration platform can provide an efficient and concise summary of the changes that allow a user to quickly understand the changes, without having to review the actual changes manually.

Since the content change generation service generates content change summaries based on a user's own interaction history with a content item, the content change summaries are unique to each user. For example, for a user who has viewed a recent historical version of a content item, the content change summaries may be significantly different than the content change summaries for a user who last viewed an older historical version of the content item. Thus, the content change generation service provides dynamically generated content summaries that reflect the user's actual view and/or interaction history with a given content item, and allows user to quickly and easily understand what changes have been made since their last viewing.

### Scalable Network Architecture for Automatic Content Generation

As described herein, the content change generation service may use content generation tools to generate content change summaries for different versions of content items. More specifically, systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding.

In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples).

In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input. Many of the examples described herein are directed to an interface that includes a generative interface panel having an input region that can receive commands, references to content, links, and other input, at least a portion of which is provided as natural language text.

In some examples, the user may engage with a button in a UI that causes the generative interface panel or a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands-after the user types a slash character, any text input after the slash character can be considered as a command to instruct the underlying system to perform a task. In some cases, the user may engage with a button in a UI that causes a content change generation service to generate a prompt for a generative service, as described herein.

Regardless of how a software platform user interface is instrumented to receive user input, the user may provide an input that includes a string of text including a natural language request or instruction (e.g., a prompt), or the user input may cause a service, such as the content change generation service, to generate a prompt that includes a natural language request or instructions. The prompt may be provided as input to an input queue including other requests from other users or other software platforms. Once the prompt is popped from the queue, it may be normalized and/or preconditioned by a preconditioning service. The preconditioning service may be provided by one or more registered plugins that are selected in accordance with an analysis of the input and/or context of the current session.

The preconditioning service can, without limitation: append additional context to the user's raw input; may insert the user's raw input into a template prompt selected from a set of prompts (also referred to herein as “predetermined query prompt text” or “predetermined prompt text”); replace ambiguous references in the user's input with specific references (e.g., replace user-directed pronouns with user IDs, replace @mentions with user IDs, and so on); correct spelling or grammar; translate the user input to another language; or other operations. Thereafter, optionally, the modified/supplemented/hydrated user input can be provided as input to a secondary queue that meters and orders requests from one or more software platforms to a generative output system, such as described herein. The generative output system receives, as input, a modified prompt and provides a continuation of that prompt as output which can be directed to an appropriate recipient, such as the graphical user interface operated by the user that initiated the request or such as a separate platform. Many configurations and constructions are possible.

### Large Language Models

An example of a generative output engine of a generative output system as described herein may be a large language model (LLM). An LLM may include a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phrase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. An LLM is typically trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation can be selected or generated using a number of techniques. In many cases, a continuation of an input prompt may be referred to more generally as “generated text” or “generated output” provided by a generative output engine as described herein.

Fundamentally all written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation. In addition, because punctuation and whitespace can serve as a portion of training data, generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt. For example, a prompt of “what is the syntax for a while loop in C and how does it work” may be continued by an LLM by providing, in addition to an explanation in natural language, a C++ compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href=′https://example link/123456>project 123456</a>”. In addition, the LLM may be configured to replace the substring “pending” with a real-time updating token associated with an API call to the project management system. In this manner, the LLM converts a static string within the document management system into richer content that facilitates convenient and automatic cross-linking between software products, and may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilitates bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### Transformer Architecture

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of attention mechanisms, including self-attention mechanisms, may be suitable.

In response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations. In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output: suitably continues the input prompt; contains offensive language or tone; provides a continuation misaligned with typical human values; and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### Generative Output Engines & Generative Output Systems

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoint, such as for configuration or for receiving input prompts. The generative output application can be further configured to provide generated text output to one or more subscribers or API clients. Many suitable interfaces can be configured to provide input to and receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:

```
{
  “prompt” : “Generate five words of placeholder text in the
English language.”,
  “API_KEY”: “hx-Y5u4zx3kaF67AzkXK1hC”,
    “user_token”: “PkcLe7Co2G-50AoIVojGJ”
}
```

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:

```
{
  “response” : “Hello world text goes here.”,
  “generation_time_ms” : 2
}
```

In some embodiments, a prompt provided as input to a generative output engine can be engineered from user input. For example, in some cases, a user input can be inserted into an engineered template prompt that itself is stored in a database and includes text that may be referred to as predetermined query prompt text or predetermined prompt text. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### Prompt Pre-Configuration, Templatizing, & Engineering

As noted above, a prompt received from a user and/or generated by a service (e.g., a content change generation service) can be preconditioned and/or parsed to extract certain content therefrom. The extracted content can be used to inform selection of a particular engineered prompt template from a database of engineered prompt templates including predetermined query prompt text or predetermined prompt text. Once the selected prompt template is selected, the extracted content can be inserted into the template to generate a populated engineered prompt template that, in turn, can be provided as input to a generative output engine as described herein. Content extraction, prompt configuration, and prompt selection may be performed by a processing plugin that is registered or otherwise available to a generative service.

In many cases, a particular engineered prompt template can be selected based on a desired task for which output of the generative output engine may be useful to assist. For example, if a user or service requires a summary of a particular document, the prompt may be a text string comprising the phrase “generate a summary of this page.” A software instance configured for prompt preconditioning—which may be referred to as a “preconditioning software instance,” “prompt preconditioning software instance,” “processing plugin,” or “plugin”—may perform one or more substitutions of terms or words in this input phrase, such as replacing the demonstrative pronoun phrase “this page” with an unambiguous unique page ID. In this example, preconditioning software instance can provide an output of “generate a summary of the page with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences.

For example, in an embodiment, the preconditioning software instance can insert a phrase that adds contextual information describing the user making the initial input and request. In this example, output of the prompt preconditioning instance may be “generate a summary of the page with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information” or “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports, and so on. For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated with the user. Similarly, the “home page in my personal space” can be replaced, contextually, with a page identifier that corresponds to that user's personal space and the page that serves as the homepage thereof. Additionally, the preconditioning instance can replace the referenced time window in the raw input prompt based on the current date and based on a calculated date two weeks in the future. With these two modifications, the modified input prompt may be “generate a table of the tasks assigned to User 1234 dating from Jan. 1, 2023-Jan. 14, 2023 (inclusive), and insert the generated table into page 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of “summarize the edits to this page made by my team since I last visited this page” could determine the user's ID, team members with close connections to that user based on a user graph, determine that the user last visited the page three weeks prior, and filter attribution of edits within the last three weeks to the current page ID based on those team members. With these modifications, the prompt provided to the generative output engine may be:

```
{
  “raw_prompt” : “summarize the edits to this page made by
my team since I last visited this page”,
  “modified_prompt” : “Generate a summary of each
paragraph tagged with an editId attribute matching editId=1,
editId=51, editId=165, editId=99 within the following HTML-
formatted content: [HTML-formatted content of the page].”
}
```

Similarly, the preconditioning service may utilize a project graph, issue graph, or other data structure that is generated using edges or relationships between system objects that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:

{
“snippet123_table_from_tasks” : “The table should be
formatted as a three-column table with multiple rows. The leftmost
column should be titled ‘Title’ and the corresponding content of
each row of this column should be the title attribute of a task. The
middle column should be titled ‘Created Date’ and the
corresponding content of each row of this column should be the
creation date of the task. The rightmost column should be titled
‘Status’ and the corresponding content of each row of this column
should be the status attribute of the selected task.”
}

The foregoing examples of modifications and supplements to input prompts are not exhaustive. Other modifications are possible. In one embodiment, the user input of “generate a table of all my tasks for the next two weeks” may be converted, supplemented, modified, and/or otherwise preconditioned to:

{
“modified_prompt” : “Find all tasks assigned to User 1234
dating from Jan 01, 2023 - Jan 14, 2023 (inclusive). Create a table
in which each found task corresponds to a respective row of that
table. The table should be formatted as a markdown table, in plain
text, with three columns. The leftmost column should be titled
‘Title’ and the corresponding content of each row of this column
should be the title attribute of a respective task. The middle column
should be titled ‘Created Date’ and the corresponding content of
each row of this column should be the creation date of the respective
task. The rightmost column should be titled ‘Status’ and the
corresponding content of each row of this column should be the
status attribute of the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents.

In yet other examples, staging of requests may be useful for other purposes.

### Authentication & Authorization

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In other cases, a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile.

In other embodiments, a prompt engineering service may be configured to request that the generative output engine append citations (e.g., back links) to each page or source from which information in a generative response was based. In these examples, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url”.

In yet other examples, a prompt engineering service may be configured to classify a user input into one of a number of classes of request. Different classes of request may be associated with different permissions handling techniques. For example, a class of request that requires a generative output engine to resource from multiple pages may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein. More generally, as noted above, a generative output engine may be a portion of a larger network and communications architecture as described herein. This network can include input queues, prompt constructors, engine selection logical elements, request routing appliances, authentication handlers and so on.

### Collaboration Platforms Integrated with Generative Output Systems

In particular, embodiments described herein are focused to leveraging generative output engines to produce content in a software platform used for collaboration between multiple users, such as documentation tools, issue tracking systems, project management systems, information technology service management systems, ticketing systems, repository systems, telecommunications systems, messaging systems, and the like, each of which may define different environments in which content can be generated by users of those systems. For example, a documentation system may define an environment in which users of the documentation system can leverage a user interface of a frontend of the system to generate documentation in respect of a project, product, process, or goal. For example, a software development team may use a documentation system to document features and functionality of the software product. In other cases, the development team may use the documentation system to capture meeting notes, track project goals, and outline internal best practices.

Other software platforms store, collect, and present different information in different ways. For example, an issue tracking system may be used to assign work within an organization and/or to track completion of work, a ticketing system may be used to track compliance with service level agreements, and so on. Any one of these software platforms or platform types can be communicably coupled to a generative output engine, as described herein, in order to automatically generate structured or unstructured content within environments defined by those systems. For example, a documentation system can leverage a generative output engine to, without limitation: summarize individual documents; summarize portions of documents; summarize multiple selected documents; generate document templates; generate document section templates; generate suggestions for cross-links to other documents or platforms; generate suggestions for adding detail or improving conciseness for particular document sections; and so on.

More broadly, it may be appreciated that a single organization may be a tenant of multiple software platforms, of different software platform types. Generally and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multitenant software platform.

For simplicity of description, the multitenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform-multitenant or otherwise—as described herein are not collocated, and communicate over a large area and/or wide area network by leveraging one or more networking protocols, but this is not required of all implementations.

A frontend of a software platform as described herein may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multitenant software platform. In many embodiments, as noted above, tenant-owned content may be stored, transmitted, and/or formatted for display by a frontend of a software platform as structured data. In particular structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third-party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multitenant software and, in particular, by a provider of suites of multitenant software platforms, each platform being configured for a different particular purpose. Herein, providers of systems or suites of multitenant software platforms are referred to as “multiplatform service providers.” Generally, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multitenant issue tracking system, a multitenant code repository service, and a multitenant documentation service. In this example, an organization that is a customer/client of the service provider may be a tenant of each of the issue tracking system, the code repository service, and the documentation service.

As with preceding examples, the organization can create and/or purchase user accounts for its employees, so that certain selected employees have access to one or more of issue tracking functionality, documentation functionality, and code repository functionality.

In this example and others, a system may leverage multiple collaboration tools to advance individual projects or goals. For example, for a single software development project, a software development team may use (1) a code repository to store project code, executables, and/or static assets, (2) a documentation service to maintain documentation related to the software development project, (3) an issue tracking system to track assignment and progression of work, and (4) a messaging service to exchange information directly between team members.

However, as organizations grow, as project teams become larger, and/or as software platforms mature and add features or adjust user interaction paradigms over time, using multiple software platforms can become inefficient for both individuals and organizations. To counteract these effects, many organizations define internal policies that employees are required to follow to maintain data freshness across the various platforms used by an organization.

For example, when a developer submits a new pull request to a repository service, that developer may also be required by the organization to (1) update a description of the pull request in a documentation service, (2) change a project status in a project management application, and/or (3) close a ticket in a ticketing or issue tracking system relating to the pull request. In many cases, updating and interacting with multiple platforms on a regular and repeating basis is both frustrating and time consuming for both individuals and organizations, especially if the completion of work of one user is dependent upon completion of work of another user.

Some solutions to these and related problems often introduce further issues and complexity. For example, many software platforms include an in-built automation engine that can expedite performance of work within that software platform. In many cases, however, users of a software platform with an in-built automation engine may not be familiar with the features of the automation engine, nor may those users understand how to access, much less efficiently utilize, that automation engine. For example, in many cases, accessing in-built automation engines of a software platform requires diving deep into a settings or options menu, which may be difficult to find.

Other solutions involve an inter-platform bridge software that allows data from one platform to be accessed by another platform. Typically, such bridging software is referred to as an “integration” between platforms. An integration between different platforms may allow content, features, and/or functionality of one platform to be used in another platform.

For example, a multiplatform service provider may host an issue tracking system and a documentation system. The provider may also supply an integration that allows issue tracking information and data objects to be shown, accessed, and/or displayed from within the documentation system. In this example, the integration itself needs to be separately maintained in order to be compliant with an organization's data sharing and/or permissions policies. More specifically, an integration must ensure that authenticated users of the documentation system that view a page that references information stored by the issue tracking system are also authorized to view that information by the issue tracking system.

Phrased in a more general way, an architecture that includes one or more integrations between tenancies of different software platforms requires multiple permissions requests that may be forwarded to different systems, each of which may exhibit different latencies, and have different response formats, and so on. More broadly, some system architectures with integrations between software platforms necessarily require numerous network calls and requests, occupying bandwidth and computational resources at both software platforms and at the integration itself, to simply share and request information and service requests for information by and between the different software platforms. This architectural complexity necessitates careful management to prevent inadvertent information disclosure.

Furthermore, the foregoing problem(s) with maintaining integrations' compliance with an organization's policies and organization-owned content access policies may be exacerbated as a provider's platform suite grows. For example, a provider that maintains three separate platforms may choose to provide three separate integrations interconnecting all three platforms. (e.g., 3 choose 2). In this example, the provider is also tasked with maintaining policy compliance associated with those three platforms and three integrations. If the provider on-boards yet another platform, a total of six integrations may be required (e.g., 4 choose 2). If the provider on-boards a fifth platform, a total of ten integrations may be required (e.g., 5 choose 2). Generally, difficulties of maintaining integrations between different software platforms (in a permissions policy compliant manner) scales exponentially with the number of platforms provided.

Further to the inadvertent disclosure risk and maintenance obligations associated with inter-platform integrations, each integration is still only configured for information sharing, and not automation of tasks. Although context switching to copy data between two integrated platforms may be reduced, the quantity of tasks required of individual users may not be substantially reduced.

Further solutions involve creating and deploying dedicated automation platforms that may be configured to operate with one, and/or perform automations of, or more platforms of a multiplatform system. These, however, much like automation engines in-built to individual platforms, may be difficult to use, access, or understand. Similarly, much like integrations described above, dedicated automation platforms require separate maintenance and employee training, in addition to licensing costs and physical or virtual infrastructure allocations to support the automation platform(s).

In still further other circumstances, many automations may take longer for a user to create than the time saved by automating that particular task. In these examples, individual users may avoid defining automations altogether, despite that, in aggregate, automation of a given task may save an organization substantial time and cost.

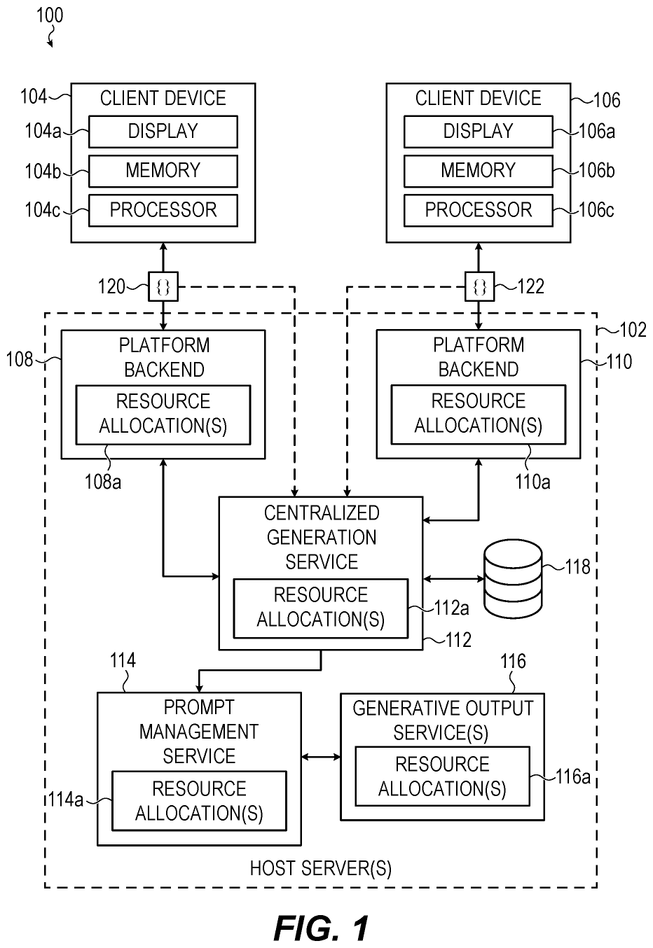

These foregoing and other embodiments are discussed below with reference to FIGS. 1-10. However, the detailed description given herein with respect to these figures is for explanation only and should not be construed as limiting.

FIG. 1 depicts system diagram that includes multiple platforms that can include and/or may receive input from a generative output engine, as described herein. The system 100 can be used to produce generative responses, which may include recommended objects, supplemental content, summaries and/or brief descriptions of content items, as described herein. The system 100 of FIG. 1 depicts an example of how multiple platforms 108, 110 may utilize a centralized generation service 112 (also referred to as a centralized content generation service 112), which may produce the summaries or brief descriptions or other generative content using a generative output engine of a generative output service 116.

The system 100 is depicted as implemented in a client-server architecture, but it may be appreciated that this is merely one example and that other communications architectures are possible. In particular the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples include information technology system management (ITSM) systems, chat platforms, messaging platforms, and the like. These backends can be communicably coupled to a generative output engine that can be leveraged to provide unique intelligent functionality to each respective backend. For example, the generative output engine can be configured to receive prompts, such as described above, to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking system. In these examples, a user of the documentation platform may input a prompt requesting a summary of the status of a particular project documented in a particular page of the documentation platform. A comprehensive continuation/response to this summary request may pull data or information from the issue tracking system as well.

A user of the client devices may trigger production of generative output in a number of suitable ways. The examples described herein include the triggering of a centralized generation service 112 (also referred to as a generative service or generative system) in response to a synchronous or scheduled processing of a set of content items that satisfy a content criteria. The generation service 112 may also be triggered in response to user input provided to a frontend application corresponding to a respective one of the platform backends 108, 110. A variety of implementations and examples are described in the following figures.

Turning to FIG. 1, a portion of the set of host servers 102 can be allocated as physical infrastructure supporting a first platform backend 108 and a different portion of the set of host servers 102 can be allocated as physical infrastructure supporting a second platform backend 110. The two different platforms maybe instantiated over physical resources provided by the set of host servers 102. Once instantiated, the first platform backend 108 and the second platform backend 110 can each communicably couple to a centralized generation service 112.

The centralized generation service 112 can be configured to cause generation and display of generative content within respective frontends of each of the first platform backend 108 and the second platform backend 110. In this manner, and as a result of this construction, each of the first platform and the second platform can be provided with a consistent or uniform user experience with respect to the generation of generative content.

In some cases, the centralized generation service 112 may provide a mechanism to request and obtain summaries of content changes between different versions of content items through selectable graphical objects and other elements from various platforms in the multiplatform environment, and communicate with the generative output engine to fulfill the summary requests and provide responses from the generative output engine back within the UI of the platforms. As a result of this centralized architecture, multiple platforms in a multiplatform environment can leverage the features of the generative output engine via the selectable graphical object, regardless of the platform of the system 100 in which the selectable graphical object resides. This provides a consistent experience to users across platforms while simplifying processes of updating or otherwise modifying the service to the generative output engine.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized generation service 112 that can be called by each respective frontend whenever it is required to present the user of that respective frontend with an interface to edit text.

For example, the documentation platform's frontend or the issue tracking platform's fronted may call upon the centralized generation service 112 to interact with a generative output engine to obtain and provide generative content (e.g., content change summaries for different versions of content items), which may occur in response to a user of the documentation platform or issue tracking platform requesting the summary via a button or other input of the selectable graphical object.

Similarly, the documentation platform's frontend or the issue tracking platform's frontend may call upon the centralized generation service 112 to interact with a generative output engine to obtain and provide a response to a question or query regarding the target content referenced by a selectable graphical object when a user of the documentation platform provides a question or query regarding the target content via an input of the selectable graphical object.

In addition, as a result of the architectures described herein, services supporting the centralized generation service 112 can be extended to include additional features and functionality that can automatically be leveraged by any further platform that incorporates selectable graphical objects, and/or otherwise integrates with the centralized generation service 112 itself.

The generative output engine service may be hosted over the host servers 102 or, in other cases, may be a software instance instantiated over separate hardware. In some cases, the generative engine service may be a third-party service that serves an API interface to which one or more of the host services and/or preconditioning service can communicably couple. The generative output engine can be configured as described above to provide any suitable output, in any suitable form or format. Examples include content to be added to user-generated content, API request bodies, replacing user-generated content, and so on.

The first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified in FIG. 1 as the client devices resources 104a-104c, respectively.

As with many embodiments described herein, the first platform frontend can be configured to communicate with the first platform backend 108 and/or the centralized generation service 112. Information can be transacted by and between the frontend, the first platform backend 108 and the centralized generation service 112 in any suitable manner or form or format. In many embodiments, as noted above, the client device 104 and in particular the first platform frontend can be configured to send an authentication token 120 along with each request transmitted to any of the first platform backend 108 or the centralized generation service 112 or the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified in FIG. 1 as the client device resources 106a-106c, respectively.

As with many embodiments described herein, the second platform frontend can be configured to communicate with the second platform backend 110 and/or the centralized generation service 112. Information can be transacted by and between the frontend, the second platform backend 110 and the centralized generation service 112 in any suitable manner or form or format. In many embodiments, as noted above, the client device 106 and in particular the second platform frontend can be configured to send an authentication token 122 along with each request transmitted to any of the second platform backend 110 or the centralized generation service 112.

As a result of these constructions, the centralized generation service 112 can provide uniform feature sets to users of either the client device 104 or the client device 106. As noted above, the centralized generation service 112 ensures that common features are available to frontends of different platforms. One such class of features provided by the centralized generation service 112 invokes output of a generative output engine of a service such as the generative output service 116. For example, as noted above, the generative output service 116 can be used to generate content, supplement content, and/or generate API requests or API request bodies that cause one or both of the first platform backend 108 or the second platform backend 110 to perform a task. In some cases, an API request generated at least in part by the generative output service 116 can be directed to another system not depicted in FIG. 1. For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

As with other embodiments described herein, the prompt management service 114 can be configured to receive user input (provided via a graphical user interface of the client device 104 or the client device 106 or from another service, such as a content change generation service) from the centralized generation service 112. The user input may include a prompt to be continued by the generative output service 116.

The prompt management service 114 can be configured to modify the user input, to supplement the user input, select a prompt from a database (e.g., the database 118) based on the user input, insert the user input into a template prompt, replace words within the user input, preform searches of databases (such as user graphs, team graphs, and so on) of either the first platform backend 108 or the second platform backend 110, change grammar or spelling of the user input, change a language of the user input, and so on. The prompt management service 114 may also be referred to herein as herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input. More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible).

In response to receiving a modified prompt as input, the generative output service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative output service 116 can be provided to the centralized generation service 112 to return to a suitable backend application, to in turn return to or perform a task for the benefit of a client device such as the client device 104 or the client device 106. More particularly, it may be appreciated that although FIG. 1 is illustrated with only the prompt management service 114 communicably coupled to the generative output service 116, this is merely one example and that in other cases the generative output service 116 can be communicably coupled to any of the client device 106, the client device 104, the first platform backend 108, the second platform backend 110, the centralized generation service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, the embodiments described herein and with particular reference to FIG. 1 relate to systems for collecting user input, modifying that user input (and/or a request that was initiated or triggered by the user input) into a particularly engineered prompt, and submitting that prompt as input to a trained large language model. Output of the LLM can be used in a number of suitable ways.

In some embodiments, user input can be provided by text input that can be provided by a user typing a word or phrase into an editable dialog box such as a rich text editing frame rendered within a user interface of a frontend application on a display of a client device. For example, the user can type a particular character or phrase in order to instruct the frontend to enter a command receptive mode. In some cases, the frontend may render an overlay user interface that provides a visual indication that the frontend is ready to receive a command from the user. As the user continues to type, one or more suggestions may be shown in a modal UI window.

These suggestions can include and/or may be associated with one or more “preconfigured prompts” that are engineered to cause an LLM to provide particular output. More specifically, a preconfigured prompt may include a static string of characters, symbols and words, that causes—deterministically or pseudo-deterministically—the LLM to provide consistent output. For example, a preconfigured prompt may be “generate a summary of changes made to all documents in the last two weeks.” Preconfigured prompts can be associated with an identifier or a title shown to the user, such as “Summarize Recent System Changes.” In this example, a button with the title “Summarize Recent System Changes” can be rendered for a user in a UI as described herein. Upon interaction with the button by the user, the prompt string “generate a summary of changes made to all documents in the last two weeks” can be retrieved from a database or other memory, and provided as input to the generative output service 116.

Suggestions rendered in a UI can also include and/or may be associated with one or more configurable or “templatized prompts” that are engineered with one or more fields that can be populated with data or information before being provided as input to an LLM. A templatized prompt may include static language that may also be referred to as “predetermined query prompt text” and may be combined with current context or content in order to construct or generate a prompt. An example of a templatized prompt may be “summarize all tasks assigned to $ {user} with a due date in the next 2 days.” In this example, the token/field/variable $ {user} can be replaced with a user identifier corresponding to the user currently operating a client device.

This insertion of an unambiguous user identifier can be preformed by the client device, the platform backend, the centralized summary generation service, the prompt management service, or any other suitable software instance. As with preconfigured prompts, templatized prompts can be associated with an identifier or a title shown to the user, such as “Show My Tasks Due Soon.” In this example, a button with the title “Show My Tasks Due Soon” can be rendered for a user in a UI as described herein. Upon interaction with the button by the user, the prompt string “summarize all tasks assigned to user123 with a due date in the next 2 days” can be retrieved from a database or other memory, and provided as input to the generative output service 116.

Suggestions rendered in UI can also include and/or may be associated with one or more “engineered template prompts” that are configured to add context to a given user input.

The context may be an instruction describing how particular output of the LLM/engine should be formatted, how a particular data item can be retrieved by the engine, or the like. As one example, an engineered template prompt may be “$ {user prompt} provide output of any table in the form of a tab delimited table formatted according to the markdown specification.” In this example, the variable $ {user prompt} may be replaced with the user prompt such that the entire prompt received by the generative output service 116 can include the user prompt and the example sentence describing how a table should be formatted.

In yet other embodiments, a suggestion may be generated by the generative output service 116. For example, in some embodiments, a system as described herein can be configured to assist a user in overcoming a cold start/blank page problem when interacting with a new document, new issue, or new board for the first time. For example, an example backend system may be Kanban board system for organizing work associated with particular milestones of a particular project. In these examples, a user needing to create a new board from scratch (e.g., for a new project) may be unsure how to begin, causing delay, confusion, and frustration.

In these examples, a system as described herein can be configured to automatically suggest one or more prompts configured to obtain output from an LLM that programmatically creates a template board with a set of template cards. Specifically, the prompt may be a preconfigured prompt as described above such as “generate a JSON document representation of a Kanban board with a set of cards each representing a different suggested task in a project for creating a new iced cream flavor.” In response to this prompt, the generative output service 116 may generate a set of JSON objects that, when received by the Kanban platform, are rendered as a set of cards in a Kanban board, each card including a different title and description corresponding to different tasks that may be associated with steps for creating a new ice cream flavor. In this manner, the user can quickly be presented with an example set of initial tasks for a new project.

In yet other examples, suggestions can be configured to select or modify prompts that cause the generative output service 116 to interact with multiple systems. For example, a suggestion in a documentation system may be to create a new document content section that summarizes a history of agent interactions in an ITSM system. In some cases, the generative output service 116 can be called more than once (and/or it may be configured to generate its own follow-up prompts or prompt templates which can be populated with appropriate information and re-submitted to the generative output service 116 to obtain further generative output). More simply, in some embodiments, generative output may be recursive, iterative, or otherwise multi-step in some embodiments.

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a.

Similarly, the second platform backend 110 may be instantiated over the resource allocations 110a (including processors, memory, storage, network communications systems, and so on). Likewise, the centralized generation service 112 is supported by a processor and memory and network connection (and/or database connections) collectively represented for simplicity as the resource allocations 112a.

The prompt management service 114 can be supported by its own resources including processors, memory, network connections, displays (optionally), and the like represented in the figure as the resource allocations 114a. In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organization's datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect key words or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized generation service 112. As further described herein, the system 100 supports content change summary generation within a content collaboration system. In one or more embodiments, as further described herein, the system 100 utilizes selectable graphical objects or other elements within a graphical user interface (GUI) that is displayed at a client device. A user may be provided, via the GUI, with an input element or object to use to request content change summaries of a target content item. The request may be provided via a designated user input like a cursor hover input or may be a selection of a selectable control (e.g., a button). The system, for example by the centralized generation service 112, may generate a prompt and provide to the generative output engine (e.g., via the generative output service 116) that prepares and outputs a generative response. The generative response may include textual, natural language content change summaries. The content change summaries may be, for example, textual summaries of the changes to the content item between a current version of a content item and a last viewed version of a content item (by the requesting user). The content change summaries may be topically organized, such that the content changes represented or summarized by the content change summaries are grouped together based on the topic, subject, or other common feature or property. Subsequent processing of the content change summaries may include identifying textual portions associated with system-specific items, and populating the summaries with system-specific mentions, links, tables, video, audio, and so on. In some cases, the system-specific mentions are populated based on permissions that are specific to the user.

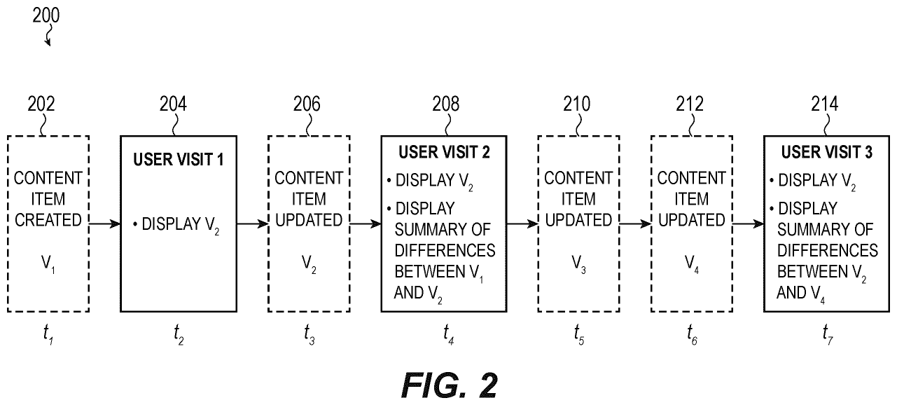

FIG. 2 illustrates an example timeline 200 of a user's interactions with a content item in a content collaboration platform. The content item may be a page or document of a content collaboration platform, an issue hosted by an issue racking platform, or the like.

More particularly, FIG. 2 illustrates various interactions by the user with respect to various versions of the content item. As described herein, this information may represent (or be stored in) an event history log. The event history log may include information about the content item (e.g., saved, cached, or archived versions of the content item), as well as information about user interactions with the content item (e.g., views, modifications, edits, etc.). The event history log may allow the system to determine how user visits and interactions relate to the version history of a content item. While FIG. 2 illustrates a portion of a single content item, and a single user's view history with respect to the content item, it will be understood that event history logs may be generated and stored for multiple content items, and an event history log for a content item may include event histories for multiple users. In some cases, event history logs may be generated for and/or associated with content items, though no particular format or data structure of an event history log is required. In some cases, event history logs for a target content item may be generated in response to request for a content change summary of a content item being viewed (e.g., in real time), based on historical content view information of the user and a version history of the target content item.

With reference to FIG. 2, a first version (v₁) of a content item may be created at time t₁. The first version of the content item may be created by the user, or by another user of the content collaboration platform.

The user may view the first version of the content item at time t₂ (and optionally modify, edit, share, etc., the first version of the content item). For example, the content item may be displayed in a content region of a graphical user interface of a frontend application. As described herein, the content region may include an editor for receiving user-generated content and displaying current content of a target content item.

Subsequent to the user viewing the first version of the content item, the content item may be edited, modified, or otherwise changed at time t₃, resulting in a new version v₂ of the content item being generated. The content collaboration platform is configured to save multiple historical versions of the content item as they are generated, such that a historical record of the content item is maintained and can be used to generate content change summaries between various versions.

Subsequent to the generation of the second version of the content item, the user views the content item again at time t₄. Since the content item has been updated since the user last viewed the content item, when the user views the content item at time t₄, the second version is displayed to the user. Additionally, in response to a trigger condition (e.g., the user selecting a selectable element indicating a request for a content change summary), a set of content change summaries may be displayed to the user, where the content change summaries provide summaries of the changes that were made to the content item since the viewer's last visit to the content item. For example, at the user's second viewing at time t₄ (viewing version 2), the previous version that the user viewed was version 1. Accordingly, content change summaries may be generated to summarize the differences between version 1 and version 2 of the content item.

As described herein, the content change summaries may be displayed to the user in a window object of a graphical user interface, or via any other suitable user interface element. The content change summaries may be arranged and/or grouped topically, such that the change summaries are displayed in a logical and easy to understand manner. For example, summaries that relate to changes in a similar area or section of a content item may be grouped and displayed together. As additional examples, summaries may be grouped by the user who made the change, or they may be grouped by the subject matter to which the change relates. Groupings of content change summaries may be displayed in association with a topic heading that provides information about the grouping (e.g., the section of the changes, the user who made the changes, the subject matter of the changes, etc.).

Returning to FIG. 2, after the user views the content item at time t₄, the content item may be updated at time t₅, producing version 3, and again at time t₆, producing version 4. As shown in the timeline 200 (or event history log), the user did not view the content item when version 3 was the current version of the content item. Thus, when the user again accessed the content item at time t₇, version 4 of the content item is displayed to the user.

In response to a request to view content change summaries for this version of the content item, the event history log is used to determine which previous version of the target content item was the last version that the user viewed. In this example, the previous version that the user viewed was version 2. Thus, a set of content change summaries may be generated based on the differences between version 2 and version 4 of the content item. Notably, the change summaries are based on the user's particular interaction history with respect to a content item, and the particular versions that are compared to generate content change summaries will change each time a user accesses a content item. Thus, for example, during one view event, a first set of content change summaries may be generated for the user, and for a subsequent view event, an entirely different set of change summaries may be generated, reflecting the particular view or interaction history of the user at that particular time. Moreover, the content change summaries may be generated in relation to a previous version of a content item that is at least two versions older than the current version of the content item. Indeed, the content change summaries may be generated between any two versions, regardless of how distant they may be in the version history.

Since different users have different interaction histories with a given content item, the content change summaries are unique to the particular interaction histories of each user. For example, with reference to FIG. 2, if another user views version 4 of the content item after last viewing version 1, then the content change summaries are generated between versions 1 and 4. If yet another user views version 4 of the content item after last viewing version 3, then the content change summaries are generated between versions 3 and 4. Thus, the content change summaries are specific to each user's interaction history with the content item.

In some cases, a user's interaction with the content item needs to satisfy a view condition in order to be registered in the event history log as a view event. For example, if a user views a content item for a few seconds (e.g., as a result of an accidental selection or only a brief scan), then the interaction may not be registered as a view event of that content item in the event history log. In some cases, the view condition is a time-based view condition (e.g., if a view event is less than a threshold duration, such as less than about 10 seconds, less than about one minute, less than about 5 minutes, less than about 10 minutes, or another suitable duration). In some cases, a time-based view condition is scaled or otherwise determined based on a length of the content item. Thus, for example, the threshold duration may be lower for shorter content items than for longer content items.

Versions of a content item may be generated and/or defined in various ways. For example, in some cases versions may be manually specified by users. More particularly, a content item may only be saved or identified as a new version in response to a user saving the content item as a new version. In another example, a new content item version is created each time a changed version of the content item is published. More particularly, when users of a content collaboration platform edit a content item, the content collaboration platform may display the content item in an edit mode, and a user can select to “publish” the content item when they are finished editing. When the content item is in the edit mode (and thus subject to user changes), other viewers of the content item may only see the most recently published version of the content item. Once an edited content item is published, the edited version becomes the generally available most recent version of the content item.

As yet another example, a new content item version may be created when a content item has been unchanged or unedited for a threshold duration. For example, the content collaboration platform may provide an editing mode in which changes to a content item are automatically saved (and optionally published) as the changes are made. Thus, the content collaboration platform may assign a new version to a content item when the content item has not been changed for a threshold duration (e.g., 10 minutes, 15 minutes, 20 minutes, or another suitable duration) after an initial change was made. This duration may indicate that a user has stopped changing the content item, and that the content item may be at a stable state. In this way, the content collaboration platform captures and saves different versions of a content item, but without having to perpetually save each change operation (e.g., each new letter, etc.).

The different versions of a content item may be cached, saved, or otherwise stored in association with the content collaboration platform. For example, each version may be stored in a data store associated with the content collaboration platform, as described herein. In some cases, users may access the historical versions of a content item (e.g., to view, copy, revert to, or perform other operations with respect to the historical version), while in other examples, the versions are not accessible by users as viewable content items.

In some cases, an event history log may also retain information about various events relating to the content item. For example, the event history log may retain information indicating what users accessed, viewed, modified, or otherwise interacted with the content item, as well as what those interactions entailed (including optionally a record of what specific changes were made by which users). Such information may be used to provide additional event summaries that summarize or list events that have occurred with respect to different versions of a content item.

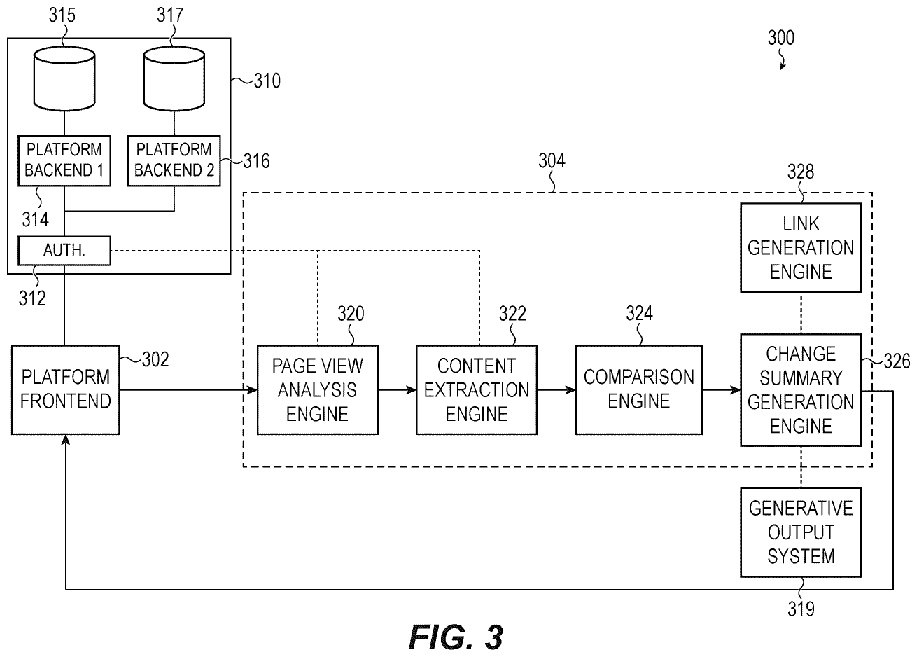

FIG. 3 depicts an example process flow for generating and displaying content change summaries within a graphical user interface of a content collaboration platform. Specifically, FIG. 3 depicts an example system 300 that includes various process modules or operations that may be implemented using hardware and networked computer components described herein. While each of the modules or processes may be described with respect to a particular software implementation, the system 300 includes the use of hardware elements including networked electronic devices, such as servers, client devices, and backend components described elsewhere in this description. A description of the hardware is not repeated with respect to FIG. 3 to reduce redundancy and improve clarity.

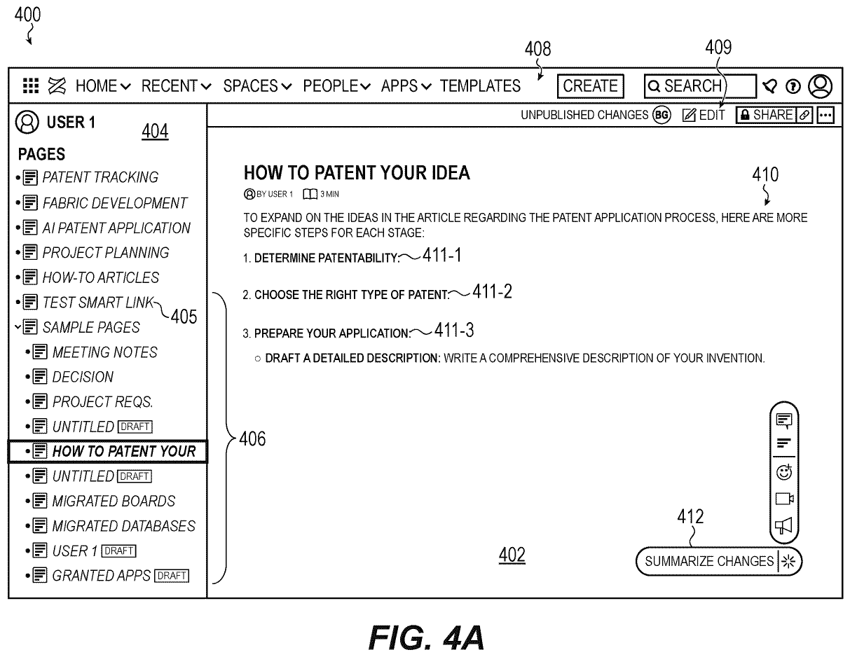

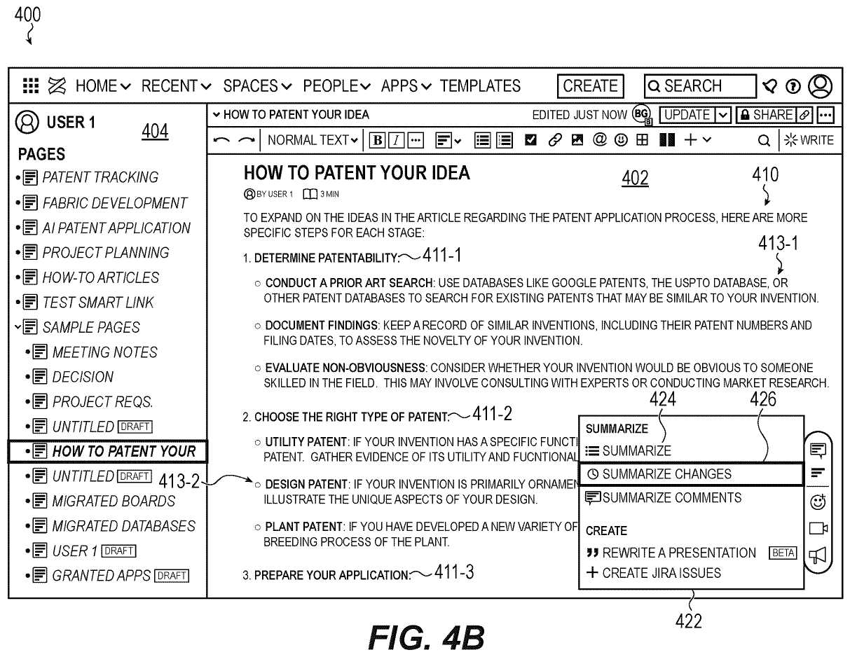

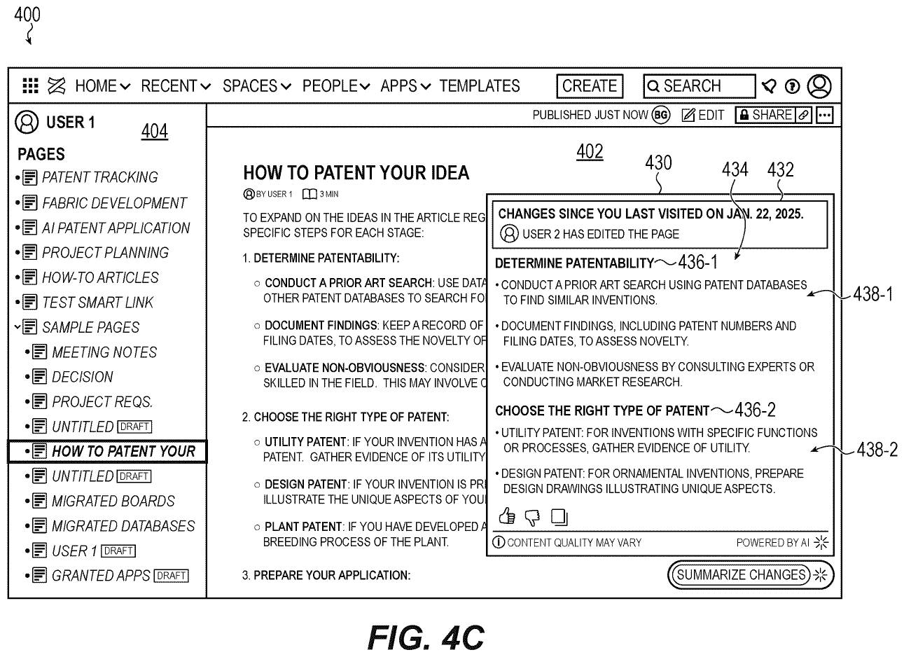

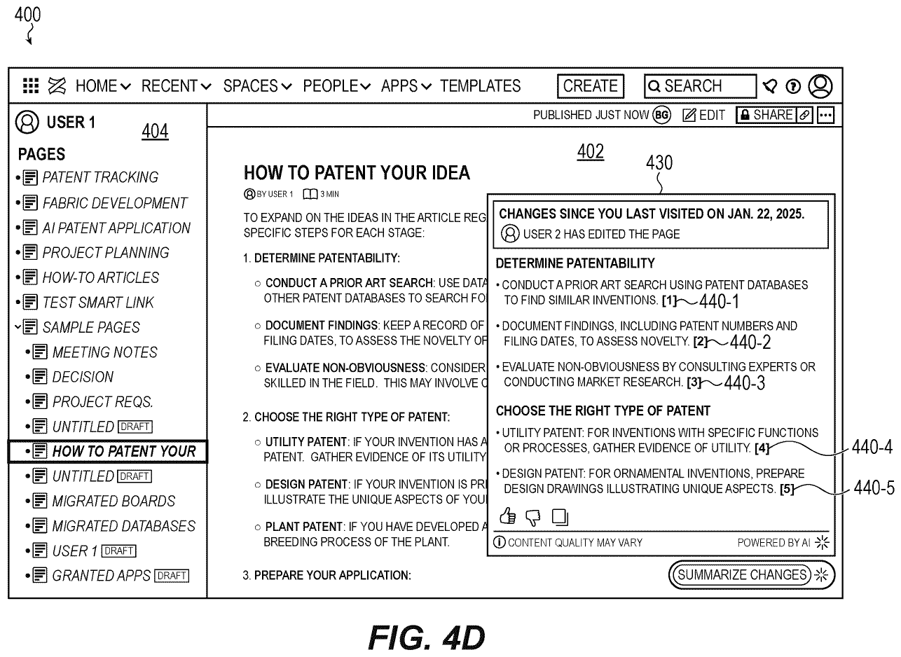

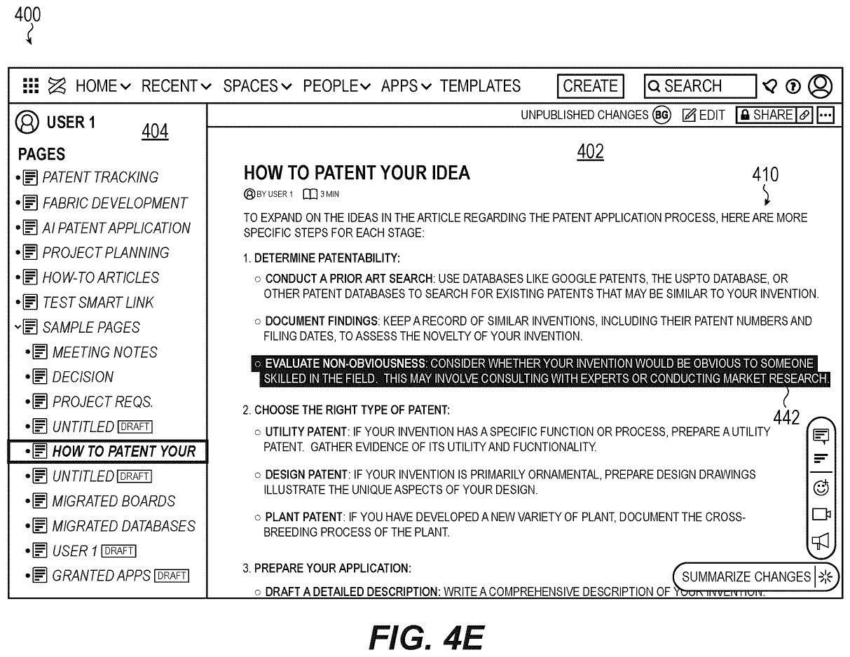

In the example system 300, the user accesses the system using a platform frontend application, which may be operating on the hardware of the client device, also referred to as platform frontend 302. The platform application of the platform frontend 302 may include a browser or other web-enabled application that is adapted for use with a web-based platform backend or other similar service over a computer network like the web or internet. In other examples, the platform application of the platform frontend 302 is a dedicated client application that is adapted to communicate with a dedicated backend or other server system via a computer network. The example system 300 includes platform backends 314, 316, which may be either web-based servers or dedicated backend servers, depending on the implementation. The frontend application of the platform frontend 302 provides a graphical user interface for the platform, which may include content creation interfaces, content viewing interfaces, and other interfaces for interacting with the content and features of the platform backend. Example graphical user interfaces are described in more detail below with respect to FIGS. 4A-6.

The platform backends 314, 316 (also referred to as backend applications operating on one or more servers or similar hardware) provides the platform functionality and access to respective content stores 315, 317. Together, the platform backends 314, 316 may form part of a federated application service or system 310. The federated system 310 may leverage a common authentication service 312, shared or linked user accounts, and may exchange information using dedicated and/or integrated communication gateways. Each platform backend 314, 316 may provide the backend for a particular type of content collaboration platform.

Example content collaboration platforms include documentation platforms or systems, issue tracking platforms or systems, information technology service management (ITSM) platforms, project management platforms, scheduling platforms or systems, software development platforms, file sharing systems, video sharing platforms, video conferencing platforms, customer relation management systems, and the like. In general, content collaboration platforms (also referred to herein as “collaboration platforms” or “collaboration services”) can be used to generate, store, and organize user-generated content. As described herein, a collaboration platform or service may include an editor that is configured to receive user input and generate user-generated content that is saved as a content item. With respect to various examples provided herein, the term “collaboration platform” or “collaboration service” may be used to refer to a documentation platform or service configured to manage electronic documents or pages created by the system users, an issue tracking platform or service that is configured to manage or track issues or tickets in accordance with an issue or ticket workflow, a source-code management platform or service that is configured to manage source code and other aspects of a software product, a manufacturing resource planning platform or service configured to manage inventory, purchases, sales activity or other aspects of a company or enterprise. In some instances, the functionality described herein may be adapted to multiple platforms or adapted for cross-platform use, through the use of a common or unitary service, such as a summary generation service. For example, the functionality described in an example may be provided with respect to a particular collaboration platform, but the same or similar functionality can be extended to other platforms by using the same service. Also, as described above, a set of host services or platforms may be accessed through a common gateway or using a common authentication scheme, which may allow a user to transition between platforms and access platform-specific content without having to enter user credentials for each platform.

In one example, a user operating a platform frontend (also referred to as a platform application operating on a client device) is authenticated with respect to one or more of the platform backends 314, 316 using an authentication service or module 312. The authentication module 312 may authenticate a user using authentication credentials that include a username and password or other authentication credentials like an authentication token or other data issued by a coordinating or recognized authentication service. In some cases, the authentication module 312 may employ or utilize a single-sign-on (SSO) service, which may be leveraged across multiple platforms or applications. Authentication of the user ensures that the platform frontend is an authorized frontend and that the user has an active and valid account with the platform backend(s) 314, 316. Authentication is also used to associate user activity with a particular user account in order to manage content permissions and provide appropriate content creation attribution. User activity logs, event history logs, user interaction logs, and other activity logs may also be associated with or tracked using the user account of the authenticated user.

Subsequent to a successful authentication, the platform frontend may cause display of a graphical user interface of the content collaboration platform. The graphical user interface may be a content creation interface in which the user can provide user-generated content for generating an electronic page or document, issue, source code, project content, or other type of content item hosted by the respective content collaboration platform. In the examples of FIGS. 4A-6, the graphical user interface is a document or page editing interface that includes an editor configured to receive user-generated content. In some implementations, the user-generated content includes text, image, video, audio, and other formats and classes of user content. The text content may be structured rich text or encoded rich text content in which editor-specific or platform-specific objects or elements may be generated. In some implementations, the content may be formatted as a structured data representation which may be formatted using JSON, XML, or other schema or a custom syntax. The structured rich text may be adapted for programmatic manipulation provided by a particular editor or rendering engine. For example the rich content may include @mention objects, selectable graphical objects, embedded content, special characters, content regions, content panels, and other similar elements.

The content change summary operations of system 300 may be initiated in response to, or subsequent to, a trigger condition being satisfied. The trigger condition may evaluate if a particular user interface event or action has occurred alone or in combination with timing criteria and other factors. Example events include a selection of a control (e.g., a UI button or other element) displayed in a graphical user interface, selection of identifiers of a pair of content item versions, or the like. The trigger event may be made in reference to a target content item, such as a content item that is currently displayed to a user. For example, as described with respect to FIG. 4A, when a content item is displayed in a graphical user interface, a selectable object may be also displayed in the graphical user interface. Selection, by the user, of the selectable object may initiate or trigger the generation and the display of content change summaries between the displayed (e.g., the current) version of the target content item, and a prior version of the target content item (e.g., the last version that was viewed by the user).

In response to or subsequent to the trigger condition being satisfied, a page view analysis engine 320 of a content change generation service 304 may obtain an event history log associated with the target content item. As described herein, the event history log may include a record of view events of the user with respect to the target content item. The page view analysis engine 320 may obtain the event history log from a platform backend 314, 316 associated with a content collaboration platform or another source of content items.

The page view analysis engine 320 may analyze the event history log to identify a cached or saved content item associated with a prior view event of the target content item (e.g., a previous version of the content item) with respect to the user account. For example, the page view analysis engine 320 may identify which previous version of the target content item was last viewed by the user associated with the user account.

The content extraction engine 322 may extract content from the current version of the target content item and from the identified previous version of the content item. The extracted content may include the content of the content item that is ultimately displayed to a viewer, and may include text, images, graphs, tables, charts, videos, editor-specific rich text elements, links to other content items, and the like. The content extraction engine 322 may replace non-textual content with textual placeholders or other identifiers, which may be preserved through any generative processing, and which may allow the non-textual content to be replaced after generative processing (e.g., a generative response may include the textual placeholder or other identifier so that the non-textual content can be inserted into the generative response).

The comparison engine 324 may determine a content delta using first content extracted from the cached or saved content item (e.g., the previously viewed version of the content item) and second content extracted from the target content item (e.g., the current version of the content item). A content delta may represent the differences between two content items. A content delta may include content that has been added or is new relative to a prior version, content that has been removed relative to a prior version, content that has been moved within a content item relative to a prior version, formatting that has been added/removed/changed relative to a prior version, among other possible difference information. The content delta may have any suitable format or data structure. In some cases, the content delta may include all of the information that characterizes the differences between two versions of a content item, such that one version of the content item and the content delta may be sufficient to reconstruct the other version of the content item.

The content delta may be generated in various ways. For example, the comparison engine 324 may use text comparison algorithms to determine the content delta. In some cases, the comparison engine 324 may use a longest common subsequence algorithm to identify content differences, though other suitable algorithms and/or data processing operations may also be used to generate the content delta. The content delta may generally represent an entire set of differences between two versions of a content item, and may be used, as described herein, to generate content change summaries for display to a user.

In some cases, a content delta between two versions of a content item may not be substantial enough to warrant content change summaries. For example, if the difference between the current version and a last-viewed version of a content item is a change in a punctuation mark or spacing between paragraphs. In such cases, the frontend 302 may not provide an option to generate content change summaries. In some cases, the comparison engine 324 determines whether a set of differences are substantial enough to warrant or justify content change summaries. More particularly, the comparison engine may determine whether the content delta satisfies a modification condition (e.g., a threshold). If the condition is satisfied, the content change generation service 304 may continue with the process of generating the content change summaries, and if not, the content change generation service 304 may not generate content change summaries. In such cases, the content change generation service 304 may instead generate a full summary (e.g., a summary of the entire content item) and display the full summary to the user. In some cases, content change summaries may be requested, generated, and displayed for versions that have any differences, regardless of whether a threshold is satisfied. The modification condition or threshold may be a certain quantity of word changes (e.g., if there have been changes (e.g., addition, removal, or modification) of at least 5 words, of least 10 words, of least 50 words, etc.), character changes (e.g., if there have been changes of at least 10 characters, of least 100 characters, etc.), punctuation changes (e.g., if there have been at least 10 punctuation changes, at least 20 punctuation changes, etc.), graphical object changes (e.g., changes (e.g., addition, removal, or modification) of at least 1 graphical object, at least 5 graphical objects, etc.) or the like. In some cases, the modification condition or threshold may be a quantity of words or characters to which a formatting change has been applied (e.g., if at least 5 words have been subjected to a formatting change).

The change summary generation engine 326 may generate a prompt for a generative output system 319 (which may correspond to the generative output service 116, the centralized generation service 112, and/or other combinations of the generative output service 116 and other services that support the functionality of the generative output service 116). The prompt may be configured to cause the generative output system 319 to produce a generative response that includes information from which content change summaries may be generated.

The prompt may include predetermined query prompt text including text-based instructions. The prompt may also include content extracted from at least one of the identified versions of the content item (e.g., from the current version of the target content item and/or from the identified previous version of the content item), as well as the content delta. As described herein, the content delta along with either version of the content item contains sufficient information to fully characterize or define both versions of the content item. Accordingly, the prompt may include the content extracted from just one or the other version.

The text based instructions of the prompt may include text that requests the generative service to generate summaries of the changes between the content items. The text may also request that the generative service provide topic headings or other classifications of the various summaries, as described herein.

In response to the prompt being provided to the generative output system 319, the change summary generation engine 326 may obtain, from the generative output system 319, a generative response. The generative response may include textual content change summaries, and/or textual information from which content change summaries may be generated. The generative response may also include topic headings or other classifications of the content change summaries. The topic headings may be based on or reflect a section, heading, or other segment of the underlying content item where the summarized change occurred. In some cases, the topic headings may reflect a common subject to which the summarized changes relate. When displayed to a user, the content change summaries may be grouped by and/or in association with a topic heading, thus providing a more organized and contextually relevant view of the changes to a content item.

The change summary generation engine 326 may process the generative response to produce a generative summary having a topically arranged list of content change summaries. As described herein, the topically arranged list of content change summaries may include at least one topic heading generated by the generative output engine, and at least one content change summary below the at least one topic heading.

The generative summary may then be displayed to the requesting user. For example, the generative summary may be displayed within a window object in the graphical user interface of the frontend application 302, as shown and described in greater detail with respect to FIGS. 4A-6.

In some cases, the generative summary may also include links or other selectable elements that are displayed in association with content change summaries. When selected by a user, a link may cause the portion of the content item that contains the change that was the subject of the content change summary to be displayed to the user. For example, the generative summary may include a content change summary such as “a description of the project was added,” along with a link associated with the summary. In response to a user selection of the link, the content item may be automatically navigated to the portion of the content item where the description of the project was added. In this way, a user can easily and quickly navigate to the locations in the content item where the summarized changes occurred.

In some cases, the content change generation service 304 includes a link generation engine 328 that is configured to generate links for inclusion in the generative summary, using the generative response. For example, the prompt for the generative output system 319 may include instructions to preserve a respective text snippet, from the extracted content and/or the content delta, for each content change summary that it generates. The text snippets may then be used by the link generation engine 328 to generate links to the location in the content item that includes the text snippet, as described herein. For example, the links may cause the frontend application to search the content item for the text snippets, thereby causing the content item to jump to the location of the text snippet (and thus the location of the change).

Since the text snippets are used to identify the location of a change in the displayed content item (e.g., the current version of the target content item), the prompt instructions may specify that the text snippets should be found in the current version of the content item, even if the text snippet is associated with a removal of content. In the case of removed content, the text snippet may be text that is present in the current version of the target content item and is adjacent or near to the location where content was removed. Notably, the content change summary need not include the text snippet, as the text snippet may be used primarily or exclusively to cause the frontend application to display the portion of the content item where the associated change occurred.

The link generation engine 328 may receive the generative response from the generative output system 319, and generate, for the text snippets in the generative response, data structures that will ultimately produce the selectable elements that are displayed to a user. The data structures may include the text snippets, such that a selection of the associated selectable element (e.g., link) will cause the frontend application to search the displayed content item for the text snippet and display the portion of the content item that includes the text snippet. For example, the frontend application in which the content item is displayed may be a browser application, and the data structure may cause a uniform resource identifier including at least a portion of the respective text snippet to be generated and/or supplied to the browser application. The uniform resource identifier may be configured to cause the browser to search the displayed content item for the portion of the text snippet that is in the uniform resource identifier.

In some cases, the link generation engine 328 is configured to analyze the text snippets in respect of the displayed content item to confirm that the link will be effective. For example, the link generation engine 328 may confirm that the text snippets in the generative response do exist in the displayed version of the content item. This may help avoid errors where the link fails to cause the content item to navigate to a relevant location. As another example, the link generation engine 328 may confirm that only one instance of the text snippet exists in the displayed version of the content item, which may ensure that the link will navigate to a correct location in the content item. In some cases, the prompt to the generative output system may include an instruction to select text snippets that are unique within the content item, which may also help ensure that a link does not inadvertently apply to multiple locations in a content item.

In some cases, the link generation engine 328 may analyze the text snippets to determine a shortest unique text snippet for a given link. For example, the link generation engine 328 may iteratively remove characters or words from the text snippet and search the content item for the shortened text snippet, until it finds a shortest unique text snippet, which may be included in the data structure of the link.

The link generation engine 328 may also be configured to incorporate editor-specific rich text elements that were in a content item in the content change summaries that are displayed to a user. For example, as described herein, text content of a content item may be structured rich text or encoded rich text content in which editor-specific or platform-specific objects or elements may be generated. In some implementations, the content may be formatted as a structured data representation which may be formatted using JSON, XML, or other schema or a custom syntax. The structured rich text may be adapted for programmatic manipulation provided by a particular editor or rendering engine. For example the rich content may include @mention objects, selectable graphical objects, embedded content, special characters, content regions, content panels, and other similar elements. Such editor-specific rich text elements may not be preserved when the extracted content from the content item is processed by the generative output system 319. Accordingly, the link generation engine 328 (or another module or service of the content change generation service 304) may replace editor-specific rich text elements in the extracted content and the content delta with placeholders before the extracted content and the content delta are provided to the generative output system 319 in the prompt. Once a generative response is received, and prior to the generative summary being displayed, the link generation engine 328 may insert the editor-specific rich text elements into the content change summaries (e.g., by replacing the placeholders with their corresponding editor-specific rich text elements).

As described herein, the change summary generation engine may also analyze an event history log to identify events occurring with respect to a content item between a timestamp associated with the current version of the content item and a timestamp of the previously viewed version of the content item. The events may include records of user activities with respect to the content item, and may include an identifier of a user and/or an identifier of a type of event. For example, the events may include a record that a first user edited the content item and that a second user shared the content item. The change summary generation engine may generate an event summary based on the set of events, and include the event summary in the display of the generative summary (e.g., in the window object of a graphical user interface). The events may include records of various types of events, including but not limited to edit events, share events, view events, presentation events (e.g., if the content item was displayed as a presentation), download events, or the like. The event summary may display the events in various ways or according to various schemes. For example, the event summary may list individual events associated with users (e.g., user 1 shared this content item, user 2 edited this content item), and/or event counts (e.g., this content item was shared 4 times, this content item was edited 12 times).

FIG. 4A depicts an example graphical user interface 400 of a content collaboration platform, as described herein. The graphical user interface 400 may be displayed subsequent to a successful authentication of a user account associated with a frontend application operating on the client device.

The graphical user interface includes a content region 402, which may include or operate an editor configured to receive user-generated content 410. In the present example, the content collaboration platform is a documentation platform and the graphical user interface is a document or page viewing and/or editing interface for managing document or page content. The same or similar techniques described herein may also apply to other content items associated with other platforms including issue content of an issue managed by an issue tracking platform, project content or a project profile managed by project management platform or project directory service, or source code of a source code management platform or service.

In the present example, the graphical user interface 400 is generated by a frontend application, which is a browser application operably coupled to a web-based backend application or platform. The interface 400 can be rendered by a client device (e.g., client device 104, 106 of FIG. 1), which may be a personal electronic device such as a laptop, desktop computer, tablet and the like. The client device can include a display with an active display area in which the user interface 400 can be rendered. The user interface can be rendered by operation of an instance of a frontend application associated with a backend application that collectively defines a software platform, as described herein. In some examples described herein, the graphical user interface 400 may be displayed subsequent to, or in response to, an authentication of a user of the content collaboration platform.

In general, the graphical user interface 400 of FIG. 4A includes a content region 402 also referred to as a content panel, which displays the content 410 of a respective electronic document or page. The content 410 may include text content, selectable graphical objects, rich text content, images, videos, and other content. The content region 402 may include or operate an editor that is configured to receive user-generated content, which is used to generate or modify the content 410 of the document. As shown in FIG. 4A, the user-generated content or content 410 may include what is referred to as structured rich text content, which may be formatted in accordance with a formatting scheme, such as HTML, XML, Atlassian Document Format (ADF), or other similar scheme or language. The particular schema may also be referred to as a platform-specific or editor-specific formatting schema. In some examples, the text content can also be displayed in line with hypertext, graphical elements and other content that is enabled by the editor instantiated by the frontend application within the content region 402. The content 410 may be organized into various segments or sections such as indicated by headings 411-1, 411-2, 411-3 (though such organization may not be present and is not required for the content change generation service to generate content change summaries for the content 410).

The graphical user interface 400 also includes a navigational region 404, also referred to as a navigational panel, which includes a set of selectable elements 405 that are selectable to cause display of respective content items or navigate to other aspects of a document space. In this example, the navigational region 404 includes a hierarchical element tree 406 also referred to as a page tree, which includes an array of selectable tree elements 405 that are hierarchically arranged in accordance with parent-child relationships between respective documents of the document space. The elements may include a short title and/or graphical elements that indicate the subject matter and type of content item associated with each respective element. Many of the elements may also be selected and moved within the hierarchical element tree 406 in order to redefine a parent-child relationship between the respective elements. The collection of elements depicted in the navigational region 404 maybe associated with a respective space, also referred to herein as a content space, page space, or document space. A space defines a collection of content items for which the space creator is the default administrator having default read, write, view, and control permissions with respect to all items within the space. Content and navigational regions 402, 404 may also be referred to herein as “panes,” “panels,” or “areas” of the graphical user interface 400.

The graphical user interface 400 also includes a control bar 408 that includes an array of selectable controls for navigating to different spaces, documents, applications, or modules. The interface 400 also includes controls 409 for managing the content and interface modes of the graphical user interface 400. Generally, the graphical user interface 400 provided by the frontend or client application may operate in one of a number of different modes. In a first mode, a user may create, edit or modify page or other digital content. This mode or state of the graphical user interface 400 may be referred to as an editor user interface, content-edit user interface, a page-edit user interface, or document-edit user interface. In a second or other mode, the user may view, search, comment on, or share the electronic document, page, or digital content. This mode or state of the graphical user interface may be referred to as a viewer user interface, content-view user interface, a page-view user interface, or document-view user interface. The graphical user interface may be implemented in a web browser client application using HTML, JavaScript, or other web-enabled protocol.

The graphical user interface 400 may allow the user to create, edit, or otherwise modify user-generated content that is stored as an electronic page. The electronic page or other digital content may be rendered on a client device by the content collaboration service upon authorization/authentication of the user by the authentication/authorization service, and based on permissions granted to the user as validated according to a user profile associated with the user. Further, the content that is rendered in the content region 402 may contain content extracted from or obtained from other content items having their own respective permissions profiles.

The content 410 displayed in FIG. 4A may correspond to a first version of a content item (or any version in a version history of the content item), and represents a particular view event of the content item for the user. More particularly, the view event represented in FIG. 4A may result in a view event record being included in an event history log for the user and/or the content item.

The graphical user interface may include a selectable element 420, which may provide options for summarizing the content item and/or generating content change summaries for the content item. In the case where the content 410 corresponds to a first version of a content item (or where the content 410 does not satisfy a modification threshold with respect to a prior viewed version), the selectable element 420 may provide options for (or directly initiate) a full summary of the content 410.

FIG. 4B illustrates a subsequent version of the content item. The version displayed in FIG. 4B may be a next version of the content item relative to the version in FIG. 4A, or it may be a later version. In either case, FIG. 4B represents a next view event of the content item for the user. As shown, the content 410 of the content item has changed relative to the earlier version, with additional content 413-1, 413-2 included under the headings 411-1, 411-2. In this example, the difference between the content items includes only text additions, though any other changes or modifications may also occur between versions, and such changes or modifications may also be summarized as described herein.

The content item in FIG. 4B may satisfy the modification threshold that results in a change summary option being presented to the user. Accordingly, in response to a user selection of the selectable element 420 (e.g., a user interface button), a set of content options 422 may be displayed. The content options 422 may include a full summary option 424 and a change summary option 426. As described herein, user selection of the full summary option 424 may result in a full summary of the entire content item being generated and displayed to the user, while the change summary option 426 may result in a set of content change summaries being generated and displayed to the user.

FIG. 4C illustrates a window object 430 displayed in the graphical user interface 400 in response to a user selection of the change summary selectable element 426 in FIG. 4B (or in response to another user input requesting a change summary of the content item). More particularly, in response to a user selection of the change summary element 426, a content change generation service may generate a set of content change summaries and event summaries for the target content item (e.g., the content item being displayed in FIGS. 4A-4E), as described with respect to FIG. 3.

The window object 430 may include the generative summary generated by the content change generation service. The generative summary may include one or more event summaries 432 (e.g., in an event summary region of the window object 430), and one or more content summaries 434 (e.g., in an event summary region of the window object 430). The content change summaries may be displayed in a topically arranged list, as described herein. For example, the topically arranged list may include at least one topic heading generated by a generative output engine (e.g., topic headings 436) and at least one content change summary below the topic heading (e.g., content change summaries 438). In this example, the topic headings 436 are the same as the section headings in the content 410 in which the summarized changes occurred, though this is only one example implementation. In other cases, the topic headings 436 may be summaries or descriptions of the section headings in the content 410 (which may be generated by a generative output engine). In yet other examples, the topic headings 436 may not correspond to headings in the content 410, but may relate to or describe the subject(s) to which the content change summaries relate. As described herein, such topic headings 436, and the groupings of content change summaries into groups having a common topic heading, may be generated by a generative output engine.

The window object 430 also includes event summaries 432. The event summaries 432 may generally represent events that have occurred with respect to the content item between the user's previous visit and current visit, as described herein. For example, the event summaries 432 may identify users who have interacted with the content item (as well as the nature of their interactions), how many times the document has been interacted with (and the nature of the interactions), and the like. The window object 430 may also provide other information relating to the user's interaction history with the content item, such as a timestamp of the previous time they viewed the content item.

As described herein, in some cases, a generative summary may include selectable elements (e.g., links) associated with content change summaries that link to the location in the content item where the summarized change occurred. FIG. 4D illustrates the graphical user interface 400 in which the generative summary includes selectable elements 440. As shown, each respective selectable element 440 is associated with (e.g., displayed adjacent or proximate to) its respective content change summary. Upon selection of a selectable element 440 by a user (e.g., clicking, tapping, or the like), the graphical user interface 400 may display the corresponding content in the content item.

More particularly, as described herein, a selection of a selectable element 440 may cause generation of a uniform resource identifier that includes a text snippet of the content that is associated with the content change summary. Upon receiving the uniform resource identifier, the frontend application (e.g., browser application) searches the content 410 for the text snippet and displays the portion of the content 410 that includes the text snippet.

FIG. 4E illustrates the graphical user interface in response to a user selection of the selectable element 440-3. In particular, selection of the selectable element 440-3 caused the generation or passing of a uniform resource identifier to the browser, where the uniform resource identifier included a text snippet that matched the highlighted text 442 in the content item. Upon receiving the uniform resource identifier, the browser searched for and navigated to the text snippet, and optionally highlighted the text snippet and/or displayed the snippet in a distinctive manner (e.g., font, formatting, etc.). As shown, the content item is only a single page, but it will be understood that the text snippet may not be in a displayed portion of the content item when the selectable element is selected, and that the content item may be scrolled or shifted in order to display the portion of the content item that includes the text snippet. FIG. 4E illustrates the window object 430 having been hidden after selection of the selectable element 440-3, though this is merely an example, and in some cases the window object 430 remains visible. In another example, the window object 430 is minimized or reduced in size. In response to a user selection of the minimized or reduced window object (or any other suitable user input), the window object 430 may be displayed again, allowing the user to view and select other content change summaries.

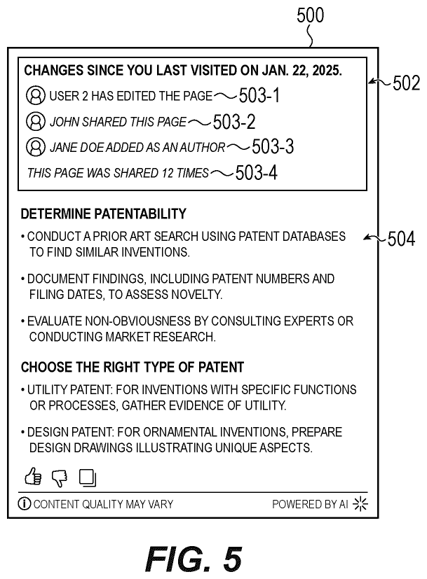

FIG. 5 illustrates another example window object 500 that may include event summaries 502 and content change summaries 504, as described herein. In this example, the event summaries 502 include summaries of multiple events with respect to the target content item. As shown, the event summaries include events relating to the requesting user (e.g., event summary 503-1), multiple other users and their interactions with the document (e.g., event summaries 503-2, 503-3), as well as cumulative or user-agnostic event summaries (e.g., event summaries 503-4). The event summaries 502 may be extracted directly from an event history log for the target content item, or they may be generated by a generative output engine using information int the event history log.

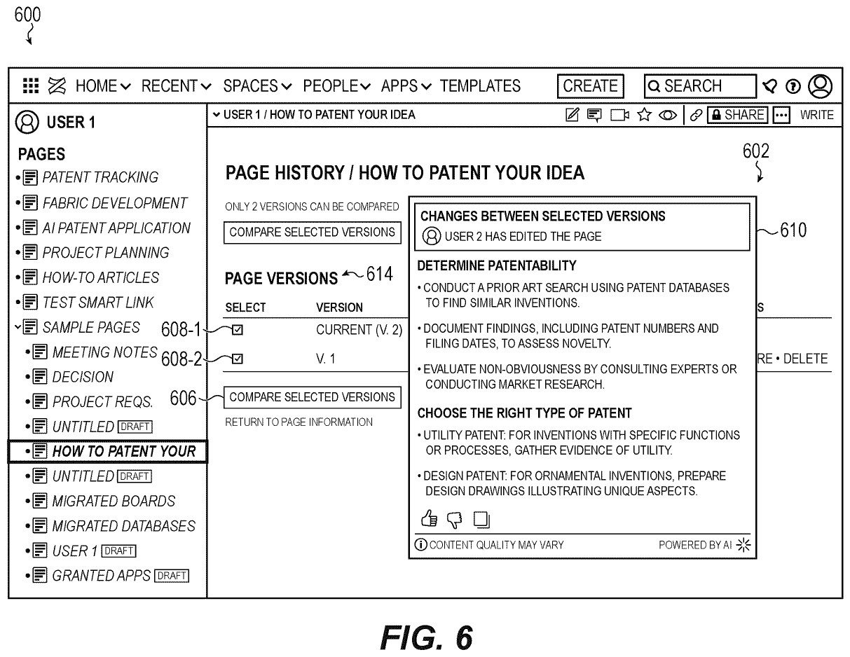

As described herein, content change summaries may be generated in response to a user input received while the user is viewing a version of a target content item. In such cases, the content change summaries may be generated between the current version of the content item (e.g., the version being viewed) and the previously viewed version. The content change generation service described herein may also be configured to generate content change summaries between any two arbitrary versions of a content item. FIG. 6 illustrates an example graphical user interface 600 that includes a content item version list view 602. The content item version list view 602 may include a list 604 of versions of a target content item. The list may include selection elements 608 for each version. A user may select the versions of the content item for which a generative summary is to be generated (which may be any arbitrary selection of two versions). The user may initiate the generative summary, such as by selecting a selectable element 606. In response to the selection of the element 606 (e.g., a trigger condition), the content change generation service may generate the generative summary (including the content change summaries and/or event summaries), and display the generative summary in a window object 610.

In the foregoing examples, the generative summary is displayed in a window object, though this is merely one example implementation. In other implementations, the generative summary may be displayed in a separate panel or region of a graphical user interface, or in a separate page or document. In some cases, a generative summary may be saved as its own content item, in which case it may appear as a selectable element in hierarchical element tree (and may be positioned relative to other elements in the tree in a manner that represents its hierarchical relationship to other content items represented in the element tree).

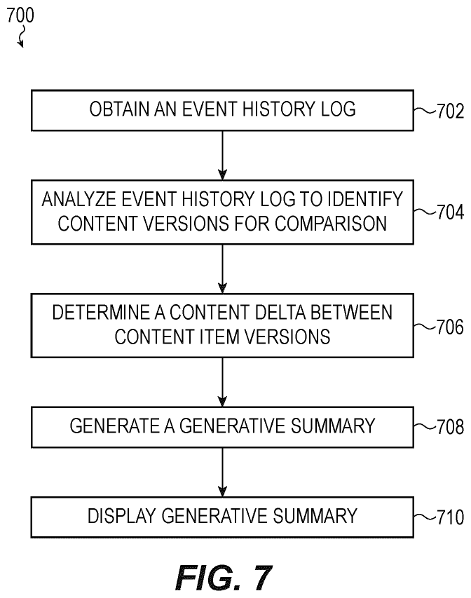

FIG. 7 depicts an example process 700 for generating generative summaries of changes between different versions of a content item. The process 700 (e.g., a computer-implemented method) may be performed by a content change generation service, such as the content change generation service 304, in conjunction with a generative service and/or any other platforms, systems, or services described herein.

The process 700 may be initiated in response to a trigger condition being satisfied, such as a user input received via a graphical user interface, as described herein. For example, the process 700 may be initiated by a user selecting a user interface element when a content item is displayed, or selecting a user interface element when two versions of a content item have been selected or identified.

At operation 702, an event history log associated with a target content item may be obtained. The event history log may include identifiers of a set of one or more previously saved versions of the target content item, as well as interaction (e.g., view) histories of one or more users with respect to the target content item. The event history log may also include events occurring with respect to the target content item. Events, content item versions, and other data in the event history log may be associated with timestamps.

At operation 704, the event history log is analyzed to identify a cached or saved content item associated with a prior view event of the content item with respect to the user account. The prior view event may correspond to the prior time (e.g., the most recent historical visit) that the user viewed the content item, which may correspond to any cached or stored version of the content item.

At operation 706, a content delta is determined using first content extracted from the cached content item (e.g., the previous version of the content item that the user viewed) and second content extracted from the target content item (e.g., the currently viewed version of the content item, or a user-selected version of the content item). The content delta may include text as well as information that specifies whether the text was added, removed, changed, modified, etc. The content delta may also include other information that characterizes changes between the compared versions of the content item, including without limitation formatting changes, image changes, chart changes, video changes, table changes, link changes, or the like. As used herein, a change may include additions, removals or deletions, formatting changes, layout changes, moves (e.g., moving text or other content from one location in a content item to another), or the like.

At operation 708, a generative summary is generated. Generating the generative summary may include generating a prompt that includes predetermined query prompt text including text-based instructions and content extracted from the cached content item (e.g., the previous version of the content item) and/or the current version of the content item. The prompt may also include the content delta. The prompt may be provided to a generative output engine, which may return a generative response that includes content change summaries representing the content changes between the identified versions of the content item. The response may also include topic headings, and may include information by which the content change summaries (and optional topic headings) may be organized into a topically arranged list of content change summaries.

As described herein, the prompt may also include instructions to preserve a respective text snippet for each content change summary of the list of content change summaries in the generative response. Generating the generative response may further include generating a selectable element for each content change summary of the list of content change summaries, and associating a uniform resource identifier with the selectable element, where the uniform resource identifier includes the text snippet and is configured to instruct a browser or other frontend application to display a portion of a content item that contains the text snippet.

At operation 710, the generative summary is displayed to a user, such as in a window object of a graphical user interface. FIGS. 4A-6 illustrate example graphical user interfaces in which generative summaries are displayed.

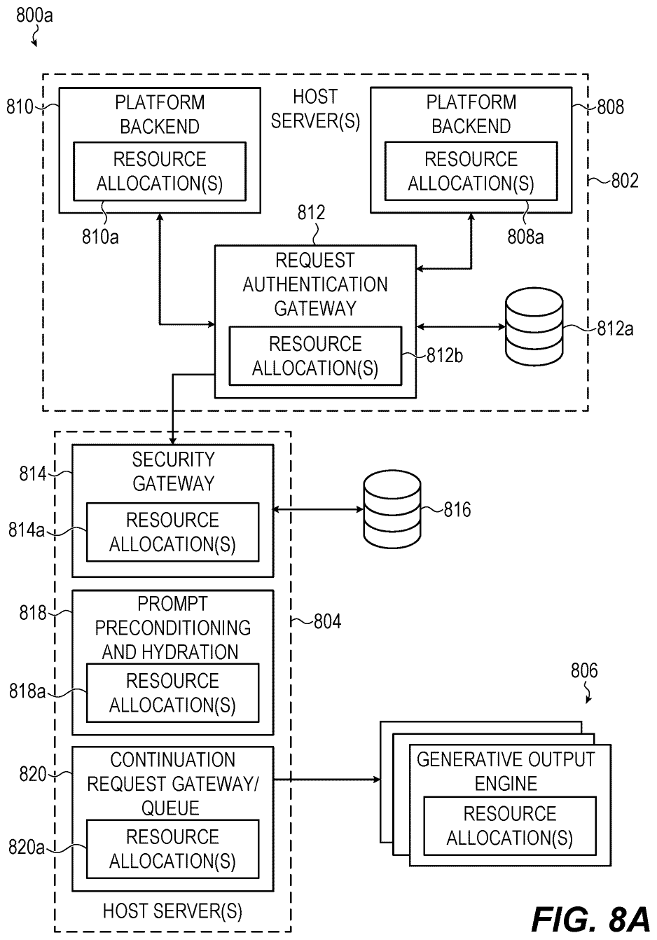

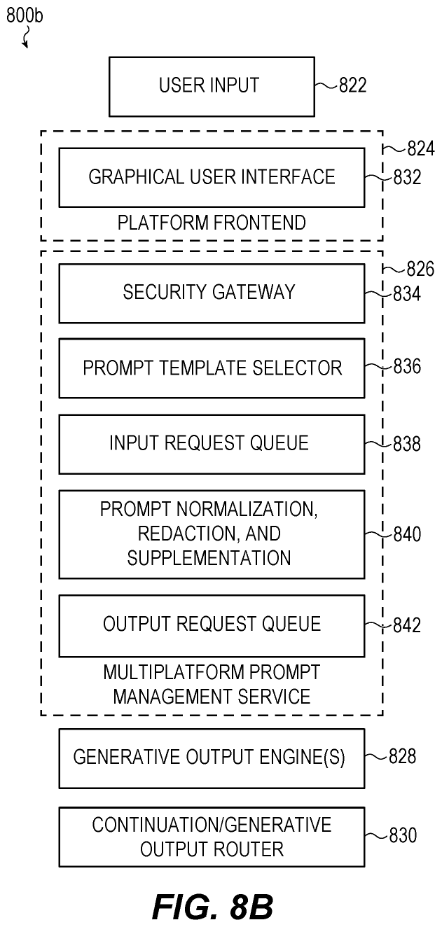

FIGS. 8A-8B depicts system diagrams and network/communication architectures that may support a system as described herein. Referring to FIG. 8A, the system 800a includes a first set of host servers 802 associated with one or more software platform backends. These software platform backends can be communicably coupled to a second set of host servers 804 purpose configured to process requests and responses to and from one or more generative output engines 806.

Specifically, the first set of host servers 802 (which, as described above can include processors, memory, storage, network communications, and any other suitable physical hardware cooperating to instantiate software) can allocate certain resources to instantiate a first and second platform backend, such as a first platform backend 808 and a second platform backend 810. Each of these respective backends can be instantiated by cooperation of processing and memory resources associated to each respective backend. As illustrated, such dedicated resources are identified as the resource allocations 808a and the resource allocations 810a.

Each of these platform backends can be communicably coupled to an authentication gateway 812 configured to verify, by querying a permissions table, directory service, or other authentication system (represented by the database 812a) whether a particular request for generative output from a particular user is authorized. Specifically, the second platform backend 810 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 812 can deny the request for insufficient permissions. This example is merely one and is not intended to be limiting; many possible authorization and authentication operations can be performed by the authentication gateway 812. The authentication gateway 812 may be supported by physical hardware resources, such as a processor and memory, represented by the resource allocations 812b.

Once the authentication gateway 812 determines that a request from a user of either platform is authorized to access data or resources implicated in service that request, the request may be passed to a security gateway 814, which may be a software instance supported by physical hardware identified in FIG. 8A as the resource allocations 814a. The security gateway 814 may be configured to determine whether the request itself conforms to one or more policies or rules (data and/or executable representations of which may be stored in a database 816) established by the organization. For example, the organization may prohibit executing prompts for offensive content, value-incompatible content, personally identifying information, health information, trade secret information, unreleased product information, secret project information, and the like. In other cases, a request may be denied by the security gateway 814 if the prompt requests beyond a threshold quantity of data.

Once a particular user-initiated prompt has been sufficiently authorized and cleared against organization-specific generative output rules, the request/prompt can be passed to a preconditioning and hydration service 818 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 818 can be a software instance supported by physical hardware represented by the resource allocations 818a. In some implementations, the hydration service 818 may also be used to rehydrate personally identifiable information (PII) or other potentially sensitive data that has been extracted from a request or data exchange in the system.

One a prompt has been modified, replaced, or hydrated by the preconditioning and hydration service 818, it may be passed to an output gateway 820 (also referred to as a continuation gateway or an output queue). The output gateway 820 may be responsible for enqueuing and/or ordering different requests from different users or different software platforms based on priority, time order, or other metrics. The output gateway 820 can also serve to meter requests to the generative output engines 806.

FIG. 8B depicts a functional system diagram of the system 800a depicted in FIG. 8A. In particular, the system 800b is configured to operate as a multiplatform prompt management service supporting and ordering requests from multiple users across multiple platforms. In particular, a user input 822 may be received at a platform frontend 824. The platform frontend 824 passes the input to a prompt management service 826 that formalizes a prompt suitable for input to a generative output engine 828, which in turn can provide its output to an output router 860 that may direct generative output to a suitable destination. For example, the output router 860 may execute API requests generated by the generative output engine 828, may submit text responses back to the platform frontend 824, may wrap a text output of the generative output engine 828 in an API request to update a backend of the platform associated with the platform frontend 824, or may perform other operations.

Specifically, the user input 822 (which may be an engagement with a button, typed text input, spoken input, chat box input, and the like) can be provided to a graphical user interface 832 of the platform frontend 824. The graphical user interface 832 can be communicably coupled to a security gateway 834 of the prompt management service 826 that may be configured to determine whether the user input 822 is authorized to execute and/or complies with organization-specific rules.

The security gateway 834 may provide output to a prompt selector 836 which can be configured to select a prompt template from a database of preconfigured prompts, templatized prompts, or engineered templatized prompts. Once the raw user input is transformed into a string prompt, the prompt may be provided as input to a request queue 838 that orders different user request for input from the generative output engine 828. Output of the request queue 838 can be provided as input to a prompt hydrator 840 configured to populate template fields, add context identifiers, supplement the prompt, and perform other normalization operations described herein. In other cases, the prompt hydrator 840 can be configured to segment a single prompt into multiple discrete requests, which may be interdependent or may be independent.

Thereafter, the modified prompt(s) can be provided as input to an output queue at 842 that may serve to meter inputs provided to the generative output engine 828.

These foregoing embodiments depicted in FIGS. 8A-8B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

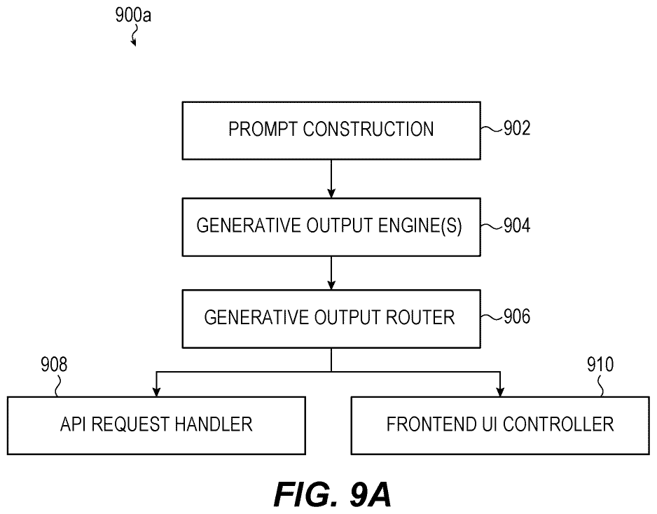

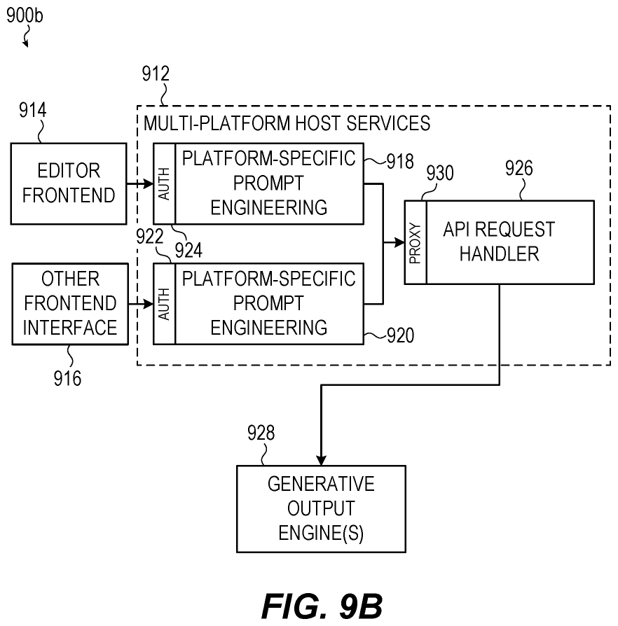

For example, although many constructions are possible, FIG. 9A depicts a simplified system diagram and data processing pipeline as described herein. The system 900a receives user input, and constructs a prompt therefrom at operation 902. After constructing a suitable prompt, and populating template fields, selecting appropriate instructions and examples for an LLM to continue, the modified constructed prompt is provided as input to a generative output engine 904. A continuation from the generative output engine 904 is provided as input to a router 906 configured to classify the output of the generative output engine 904 as being directed to one or more destinations. For example, the router 906 may determine that a particular generative output is an API request that should be executed against a particular API (e.g., such as an API of a system or platform as described herein). In this example, the router 906 may direct the output to an API request handler 908. In another example, the router 906 may determine that the generative output may be suitably directed to a graphical user interface/frontend. For example, a generative output may include content change summaries between two versions of a content item, which may be displayed to a user, as described with respect to FIGS. 2-6.

Another example architecture is shown in FIG. 9B, illustrating a system providing prompt management, and in particular multiplatform prompt management as a service. The system 900b is instantiated over cloud resources, which may be provisioned from a pool of resources in one or more locations (e.g., datacenters). In the illustrated embodiment, the provisioned resources are identified as the multi-platform host services 912.

The multi-platform host services 912 can receive input from one or more users in a variety of ways. For example, some users may provide input via an editor region 914 of a frontend, such as described above. Other users may provide input by engaging with other user interface elements 916 unrelated to common or shared features across multiple platforms. Specifically, the second user may provide input to the multi-platform host services 912 by engaging with one or more platform-specific user interface elements. In yet further examples, one or more frontends or backends can be configured to automatically generate one or more prompts for continuation by generative output engines as described herein. More generally, in many cases, user input may not be required, and prompts may be requested and/or engineered automatically.

The multi-platform host services 912 can include multiple software instances or microservices each configured to receive user inputs and/or proposed prompts and configured to provide, as output, an engineered prompt. In many cases, these instances—shown in the figure as the platform-specific prompt engineering services 918, 920—can be configured to wrap proposed prompts within engineered prompts retrieved from a database such as described above.

In many cases, the platform-specific prompt engineering services 918, 920 can be each configured to authenticate requests received from various sources. In other cases, requests from editor regions or other user interface elements of particular frontends can be first received by one or more authenticator instances, such as the authentication instances 922, 924. In other cases, a single centralized authentication service can provide authentication as a service to each request before it is forwarded to the platform-specific prompt engineering services 918, 920.

Once a prompt has been engineered/supplemented by one of the platform-specific prompt engineering services 918, 920, it may be passed to a request queue/API request handler 926 configured to generate an API request directed to a generative output engine 928 including appropriate API tokens and the engineered prompt as a portion of the body of the API request. In some cases, a service proxy 930 can interpose the platform-specific prompt engineering services 918, 920 and the request queue/API request handler 926, so as to further modify or validate prompts prior to wrapping those prompts in an API call to the generative output engine 928 by the request queue/API request handler 926 although this is not required of all embodiments.

These foregoing embodiments depicted in FIGS. 1A-10 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output one a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

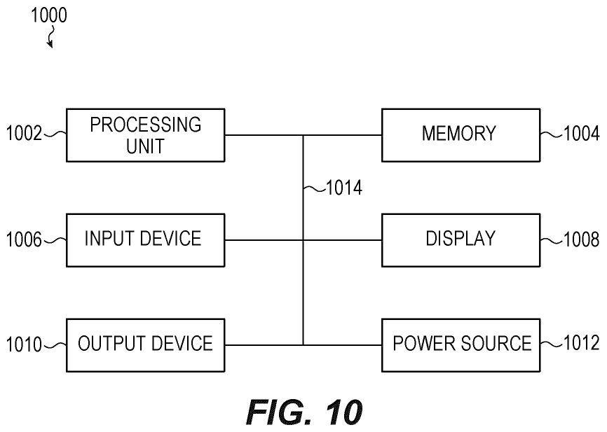

FIG. 10 shows a sample electrical block diagram of an electronic device 1000 that may perform the operations described herein. The electronic device 1000 may in some cases take the form of any of the electronic devices described with reference to FIGS. 1-9B, including client devices, and/or servers or other computing devices associated with the system 100. The electronic device 1000 can include one or more of a processing unit 1002, a memory 1004 or storage device, input devices 1006, a display 1008, output devices 1010, and a power source 1012. In some cases, various implementations of the electronic device 1000 may lack some or all of these components and/or include additional or alternative components.

The processing unit 1002 can control some or all of the operations of the electronic device 1000. The processing unit 1002 can communicate, either directly or indirectly, with some or all of the components of the electronic device 1000. For example, a system bus or other communication mechanism 1014 can provide communication between the processing unit 1002, the power source 1012, the memory 1004, the input device(s) 1006, and the output device(s) 1010.

The processing unit 1002 can be implemented as any electronic device capable of processing, receiving, or transmitting data or instructions. For example, the processing unit 1002 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1000 can be controlled by multiple processing units. For example, select components of the electronic device 1000 (e.g., an input device 1006) may be controlled by a first processing unit and other components of the electronic device 1000 (e.g., the display 1008) may be controlled by a second processing unit, where the first and second processing units may or may not be in communication with each other.

The power source 1012 can be implemented with any device capable of providing energy to the electronic device 1000. For example, the power source 1012 may be one or more batteries or rechargeable batteries. Additionally, or alternatively, the power source 1012 can be a power connector or power cord that connects the electronic device 1000 to another power source, such as a wall outlet.

The memory 1004 can store electronic data that can be used by the electronic device 1000. For example, the memory 1004 can store electronic data or content such as, for example, audio and video files, documents and applications, device settings and user preferences, timing signals, control signals, and data structures or databases. The memory 1004 can be configured as any type of memory. By way of example only, the memory 1004 can be implemented as random access memory, read-only memory, flash memory, removable memory, other types of storage elements, or combinations of such devices.

In various embodiments, the display 1008 provides a graphical output, for example associated with an operating system, user interface, and/or applications of the electronic device 1000 (e.g., a content collaboration platform user interface, a chat user interface, an issue-tracking user interface, an issue-discovery user interface, etc.). In one embodiment, the display 1008 includes one or more sensors and is configured as a touch-sensitive (e.g., single-touch, multi-touch) and/or force-sensitive display to receive inputs from a user. For example, the display 1008 may be integrated with a touch sensor (e.g., a capacitive touch sensor) and/or a force sensor to provide a touch- and/or force-sensitive display. The display 1008 is operably coupled to the processing unit 1002 of the electronic device 1000.

The display 1008 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1008 is positioned beneath and viewable through a cover that forms at least a portion of an enclosure of the electronic device 1000.

In various embodiments, the input devices 1006 may include any suitable components for detecting inputs. Examples of input devices 1006 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1006 may be configured to detect one or more particular types of input and provide a signal (e.g., an input signal) corresponding to the detected input. The signal may be provided, for example, to the processing unit 1002.

As discussed above, in some cases, the input device(s) 1006 include a touch sensor (e.g., a capacitive touch sensor) integrated with the display 1008 to provide a touch-sensitive display. Similarly, in some cases, the input device(s) 1006 include a force sensor (e.g., a capacitive force sensor) integrated with the display 1008 to provide a force-sensitive display.

The output devices 1010 may include any suitable components for providing outputs. Examples of output devices 1010 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 1010 may be configured to receive one or more signals (e.g., an output signal provided by the processing unit 1002) and provide an output corresponding to the signal.

In some cases, input devices 1006 and output devices 1010 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1002 may be operably coupled to the input devices 1006 and the output devices 1010. The processing unit 1002 may be adapted to exchange signals with the input devices 1006 and the output devices 1010. For example, the processing unit 1002 may receive an input signal from an input device 1006 that corresponds to an input detected by the input device 1006. The processing unit 1002 may interpret the received input signal to determine whether to provide and/or change one or more outputs in response to the input signal. The processing unit 1002 may then send an output signal to one or more of the output devices 1010, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

1. A computer-implemented method for generating and displaying content change summaries within a graphical user interface of a content collaboration platform, the method comprising:
in accordance with a successful authentication of a user account of a user operating a frontend application on a client device, causing display of the graphical user interface of the content collaboration platform, the graphical user interface including a content region including an editor for receiving user-generated content and displaying current content of a target page comprising rich text elements;
in response to a trigger condition being satisfied, obtaining an event history log associated with the target page;
analyzing the event history log to identify a cached page associated with a prior view event of the target page with respect to the user account;
determining a content delta using first content extracted from the cached page and second content extracted from the target page;
replacing, by a content change generation service, the rich text elements within the first content and the content delta with static textual placeholders;
causing generation of a prompt, the prompt comprising:
predetermined query prompt text including text-based instructions;
the first content; and
the content delta;
obtaining a generative response from a generative output engine, the generative response produced in response to the prompt being provided to the generative output engine;
processing the generative response to produce a generative summary having a topically arranged list of content change summaries comprising:
locating the static textual placeholders within the generative response; and
rehydrating the generative response comprising re-inserting the rich text elements into the topically arranged list of content change summaries at positions corresponding to the static textual placeholders; and
causing display of the generative summary within a window object in the graphical user interface.

2. The computer-implemented method of claim 1, wherein:
the prompt further includes instructions to generate the list of content change summaries, each content change summary of the list of content change summaries used to generate the topically arranged list of content change summaries;
the prompt further includes instructions to preserve a respective text snippet for each content change summary of the list of content change summaries in the generative response;
processing the generative response includes generating a selectable element for each content change summary of the list of content change summaries; and
user selection of a particular selectable element causes the frontend application to cause display of a respective portion of the target page containing the respective text snippet.

3. The computer-implemented method of claim 2, wherein:
the frontend application is a browser application; and
selection of the particular selectable element causes generation of a uniform resource identifier including at least a portion of the respective text snippet.

4. The computer-implemented method of claim 1, wherein the topically arranged list of content change summaries comprises:
at least one topic heading generated by the generative output engine; and
at least one content change summary below the at least one topic heading.

5. The computer-implemented method of claim 1, further comprising:
analyzing the event history log to identify a set of events occurring between a timestamp associated with the cached page and a timestamp of the target page;
generating an event summary based on the set of events; and
causing display of the event summary in the window object of the graphical user interface.

6. The computer-implemented method of claim 1, further comprising:
subsequent to causing display of the generative summary and in response to a subsequent trigger condition, determining a subsequent content delta;
in accordance with a determination that the subsequent content delta does not satisfy a modification threshold, causing generation of a full summary of the current content; and
causing display of the full summary within the window object.

7. The computer-implemented method of claim 1, wherein:
the current content includes editor-specific rich text elements;
the editor-specific rich text elements are replaced with placeholders in the first content extracted from the cached page and in the content delta; and
prior to displaying the generative summary, the editor-specific rich text elements are inserted into the topically arranged list of content change summaries.

8. The computer-implemented method of claim 1, wherein the prior view event corresponds to a most recent historical page view event associated with the user account and the target page.

9. A system of a content collaboration platform, the system comprising:
one or more processing units;
computer readable memory storing computer readable instructions that when executed by the one or more processing units cause the system to:
subsequent to an authentication of a user account of a user operating a frontend application on a client device, cause display of a graphical user interface of the content collaboration platform, the graphical user interface including a content region displaying current content of a target document;
identify a previously saved document associated with a prior view event with respect to the user account comprising rich text elements;
determine a content delta using first content extracted from the previously saved document and second content extracted from the target document;
replace, by a content change generation service, the rich text elements within the first content and the content delta with static textual placeholders;
cause generation of a prompt, the prompt comprising:
predetermined query prompt text including text-based instructions;
the first content; and
the content delta;
obtain a generative response from a generative output engine, the generative response produced in response to the prompt being provided to the generative output engine;
process the generative response to produce a generative summary having a set of content change summaries comprising:
locating the static textual placeholders within the generative response; and
rehydrating the generative response comprising re-inserting the rich text elements into the set of content change summaries at positions corresponding to the static textual placeholders; and
cause display of the generative summary within a window object in the graphical user interface.

10. The system of claim 9, wherein:
the generative summary includes a set of selectable elements, each selectable element positioned adjacent to a respective content change summary of the set of content change summaries; and
selection of a particular selectable element causes the graphical user interface to display a respective portion of the target document corresponding to a particular content change summary displayed adjacent to the particular selectable element.

11. The system of claim 9, wherein the generative summary comprises a set of topic headings generated by the generative output engine, wherein each topic heading is associated with at least one content change summary of the set of content change summaries.

12. The system of claim 9, wherein the computer readable instructions further cause the system to:
subsequent to causing display of the generative summary, determine a subsequent content delta;
in accordance with a determination that the subsequent content delta does not satisfy a modification threshold, cause generation of a full summary of the current content of the target document; and
cause display of the full summary within the window object.

13. The system of claim 9, wherein identification of the previously saved document is performed in response to a user selection of a selectable control displayed in the graphical user interface.

14. The system of claim 9, wherein:
identification of the previously saved document is performed by analyzing an event history log of the target document; and
the previously saved document is associated with a prior view event of the event history log with respect to the user account.

15. A computer-implemented method for generating and displaying content change summaries within a graphical user interface of a content collaboration platform, the method comprising:
causing display of the graphical user interface of the content collaboration platform, the graphical user interface including an event history log for a target content item, the event history log including identifiers of a set of one or more previously saved versions of the target content item, the target content item comprising rich text elements;
in response to a user input, identifying a particular previously saved version of the target content item;
determining a content delta using first content extracted from the particular previously saved version of the target content item and second content extracted from a current version of the target content item;
replacing, by a content change generation service, the rich text elements within the first content, the second content, and the content delta with static textual placeholders;
causing generation of a prompt, the prompt comprising:
predetermined query prompt text including text-based instructions;
one or more of the first content or the second content; and
the content delta;
obtaining a generative response from a generative output engine, the generative response produced in response to the prompt being provided to the generative output engine;
processing the generative response to produce a generative summary having a set of content change summaries comprising:
locating the static textual placeholders within the generative response; and
rehydrating the generative response comprising re-inserting the rich text elements into the set of content change summaries at positions corresponding to the static textual placeholders; and
causing display of the generative summary within a window object in the graphical user interface.

16. The computer-implemented method of claim 15, wherein:
the graphical user interface is displayed subsequent to a successful authentication of a user account associated with a frontend application operating on a client device; and
the event history log includes one or more events with respect to the set of one or more previously saved versions of the target content item.

17. The computer-implemented method of claim 15, wherein:
the method further comprises analyzing the event history log to identify a set of events occurring between a timestamp associated with the particular previously saved version of the target content item and a timestamp of the current version of the target content item;
generating an event summary based on the set of events; and
causing display of the event summary in the window object of the graphical user interface.

18. The computer-implemented method of claim 15, wherein the particular previously saved version of the target content item is an item that is at least two versions older than the current version of the target content item.

19. The computer-implemented method of claim 15, wherein one or more of the set of one or more previously saved versions of the target content item is generated in response to a publication of the target content item.

20. The computer-implemented method of claim 15, wherein:
the content collaboration platform is one of:
a document management platform; or
an issue tracking platform; and
the target content item is one of an electronic document hosted by the document management platform or an issue hosted by the issue tracking platform.
